(19) United States
(12) Patent Application Publication
(10) Pub. No.: US 2024/0377206 A1
(43) Pub. Date: Nov. 14, 2024

(54) USER INTERFACES FOR DYNAMIC NAVIGATION ROUTES

(71) Applicant: Apple Inc., Cupertino, CA (US)

(72) Inventor: Nick PROVENZANO, San Francisco, CA (US)

(21) Appl. No.: 18/658,828

(22) Filed: May 8, 2024

Related U.S. Application Data
(60) Provisional application No. 63/506,071, filed on Jun. 3, 2023.
(60) Provisional application No. 63/501,130, filed on May 9, 2023.

(51) Int. Cl. G01C 21/34; G01C 21/36

(52) U.S. Cl. CPC G01C 21/3415; G01C 21/3469; G01C 21/3484; G01C 21/3614

(57) ABSTRACT

Some embodiments described in this disclosure are directed to one or more electronic devices that are configured to provide navigation routes that can be modified to include fueling stations. Some embodiments described in this disclosure are directed to one or more electronic devices that are configured to provides the navigation routes in accordance with user preferences.

### CROSS REFERENCE TO RELATED APPLICATIONS

This application claims the benefit of U.S. Provisional Application No. 63/506,071, filed Jun. 3, 2023 and U.S. Provisional Application No. 63/501,130, filed May 9, 2023, the contents of which are herein incorporated by reference in their entireties for all purposes.

### FIELD OF THE DISCLOSURE

This relates generally to user interfaces that enable navigation along routes.

### BACKGROUND OF THE DISCLOSURE

User interaction with electronic devices has increased significantly in recent years. These devices can be devices such as computers, tablet computers, televisions, multimedia devices, mobile devices, and the like.

In some circumstances, users may wish to obtain navigation directions. Enhancing the user's interactions with a device improves the user's experience with the device and decreases user interaction time, which is particularly important operating vehicles.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY OF THE DISCLOSURE

Some embodiments described in this disclosure are directed to one or more electronic devices that are configured to provide navigation routes that can be modified to include or not include fueling stations. By providing navigation routes with this information and the ability to modify the navigation routes based on fueling station information, a device decreases time and processing required to determine such navigational routes, which is particularly important when operating and/or planning to operate a vehicle. The full descriptions of the embodiments are provided in the Drawings and the Detailed Description, and it is understood that the Summary provided above does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6P illustrate exemplary ways in which electronic devices present navigation routes in accordance with user preferences in accordance with some embodiments of the disclosure.

FIG. 7 is a flow diagram illustrating a method of presenting navigation routes in accordance with user preferences in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices to provide navigation routes that are able to be determined in light of user preferences. Such techniques can reduce the cognitive burden on a user who uses such devices and/or wishes to control their use of such devices. Further, such techniques can reduce processor and battery power otherwise wasted on redundant user inputs manually determining such navigation routes.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and/or iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

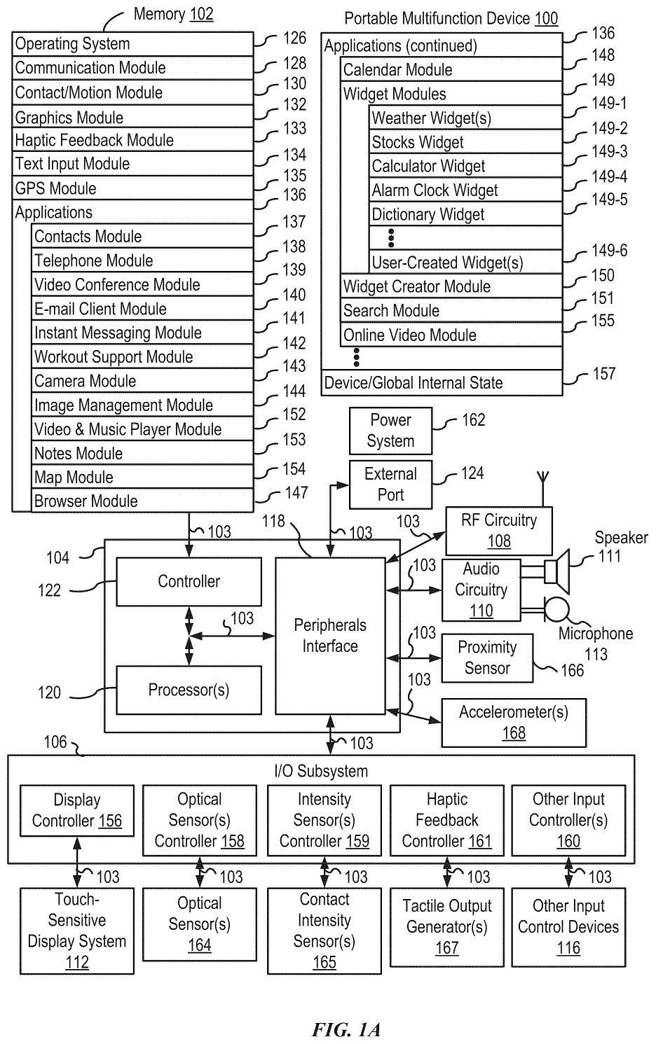

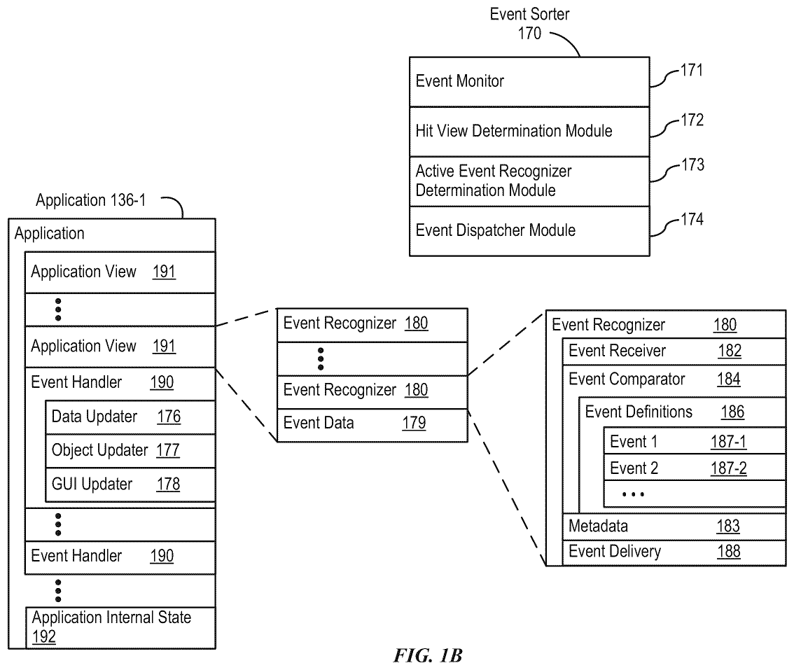

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

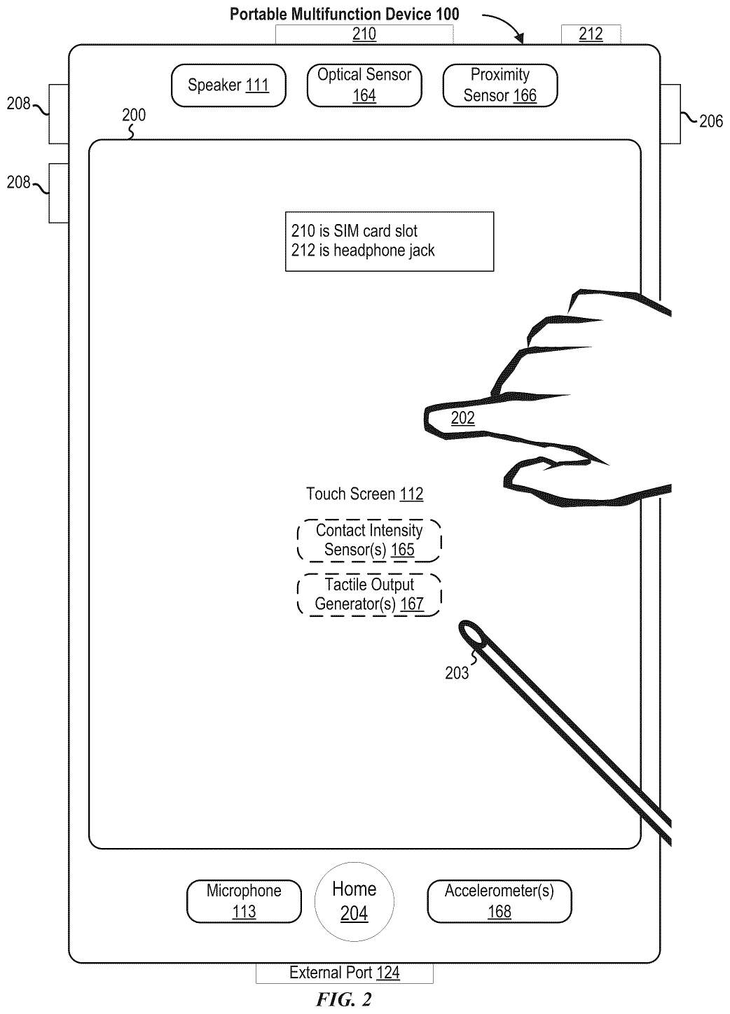

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

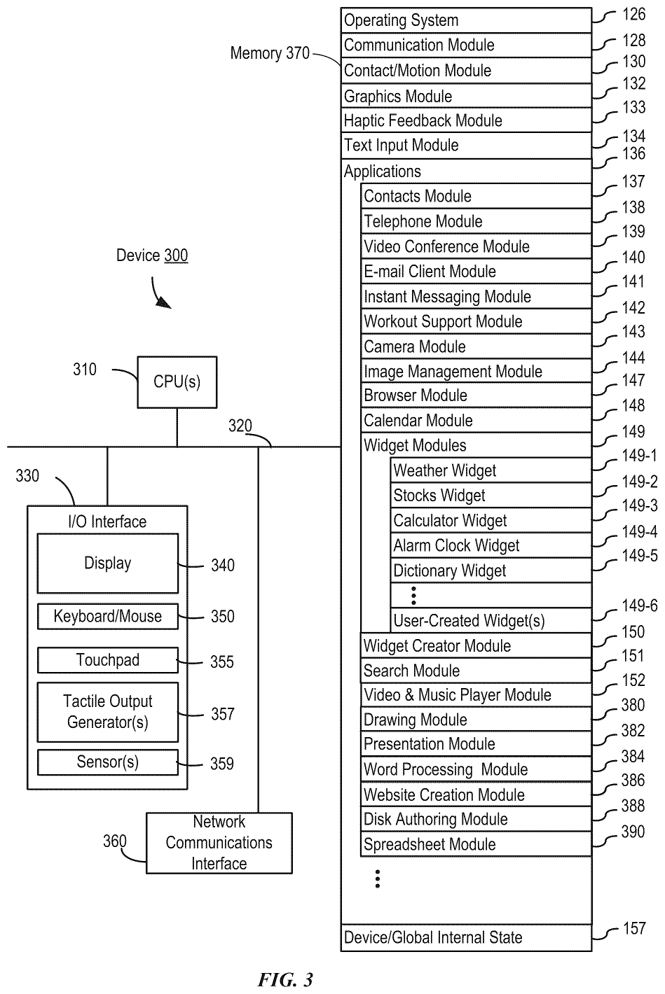

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and/or terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

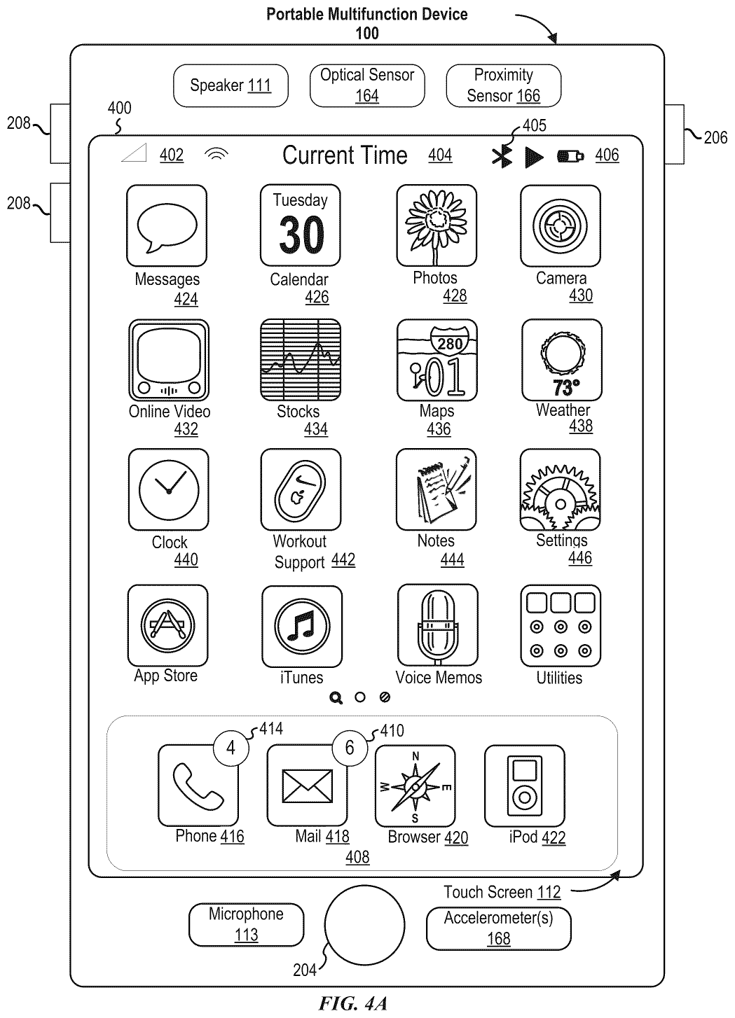

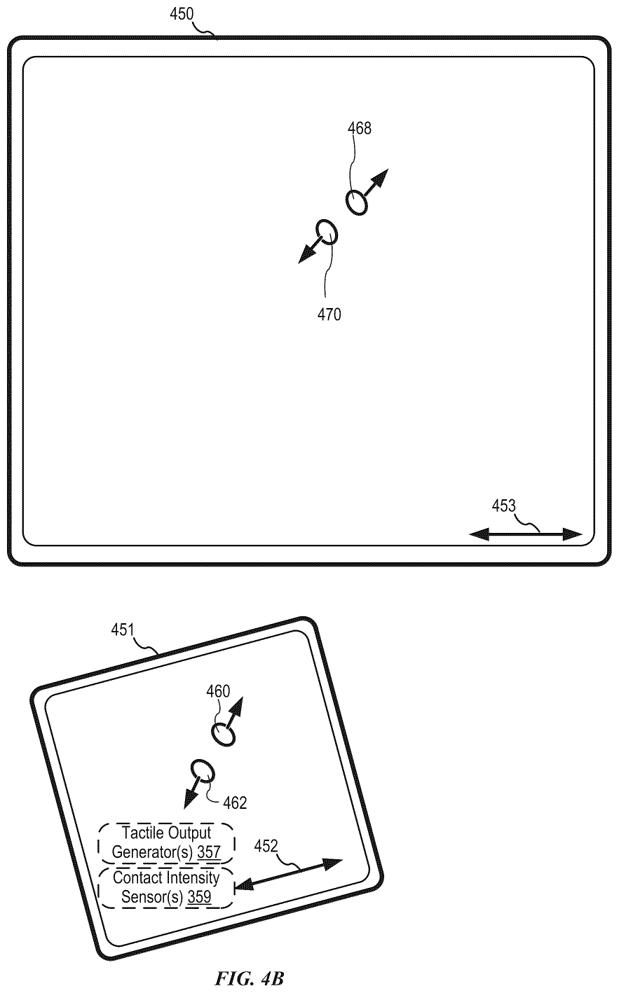

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

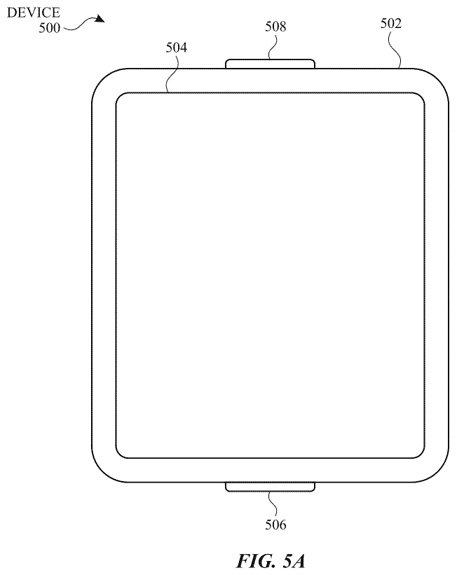

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

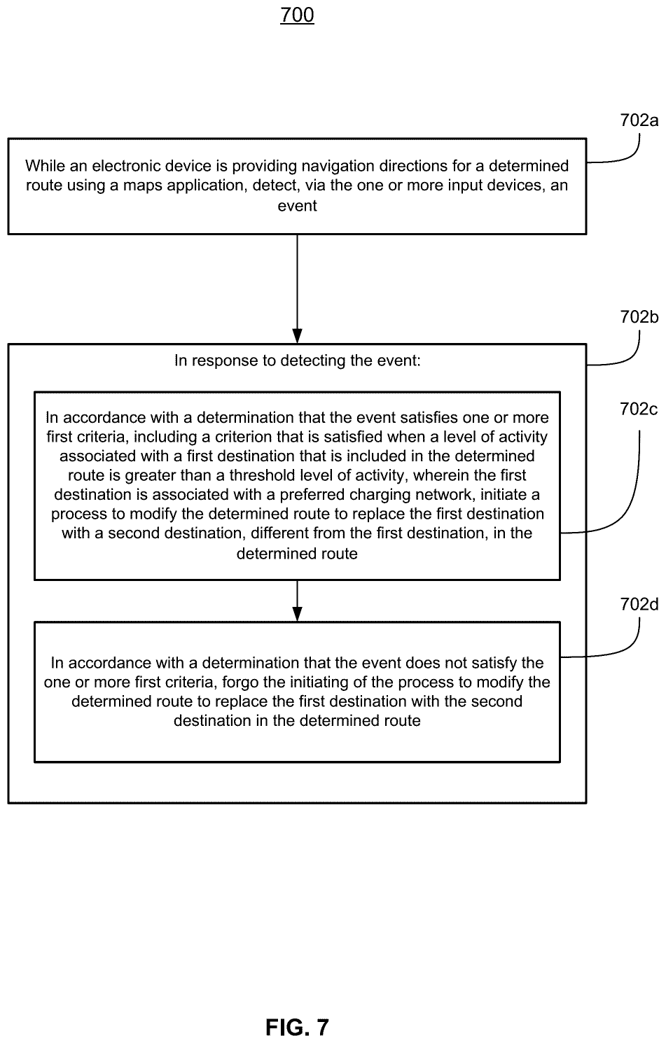

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Dynamic Replacement of Destinations Along Navigation Routes

Users interact with electronic devices in many different manners. In some embodiments, an electronic device is associated with one or more user-specified settings a vehicle In some embodiments, the electronic device is configured to present one or more proposed navigation routes based on a fueling network associated with the vehicle and/or chosen using user-specified settings and is configured to dynamically replace a destination along a selected route to a fueling network associated with the vehicle and/or chosen using user-specified settings. The embodiments described below provide ways in which an electronic device facilitates navigation and modification along navigation routes, thus enhancing a user's interactions with the electronic device. Enhancing interactions with a device reduces the amount of time needed by a user to perform operations, and thus reduces the power consumption of the device, improves efficiency of determining and modifying navigation routes, and improves user awareness of their physical surroundings. It is understood that people use devices. When a person uses a device, that person is optionally referred to as a user of the device.

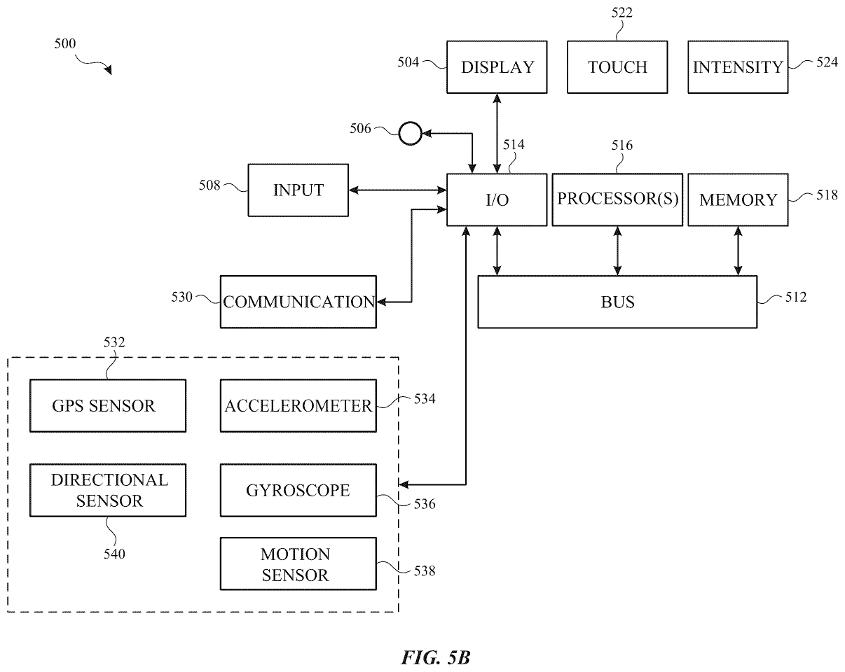

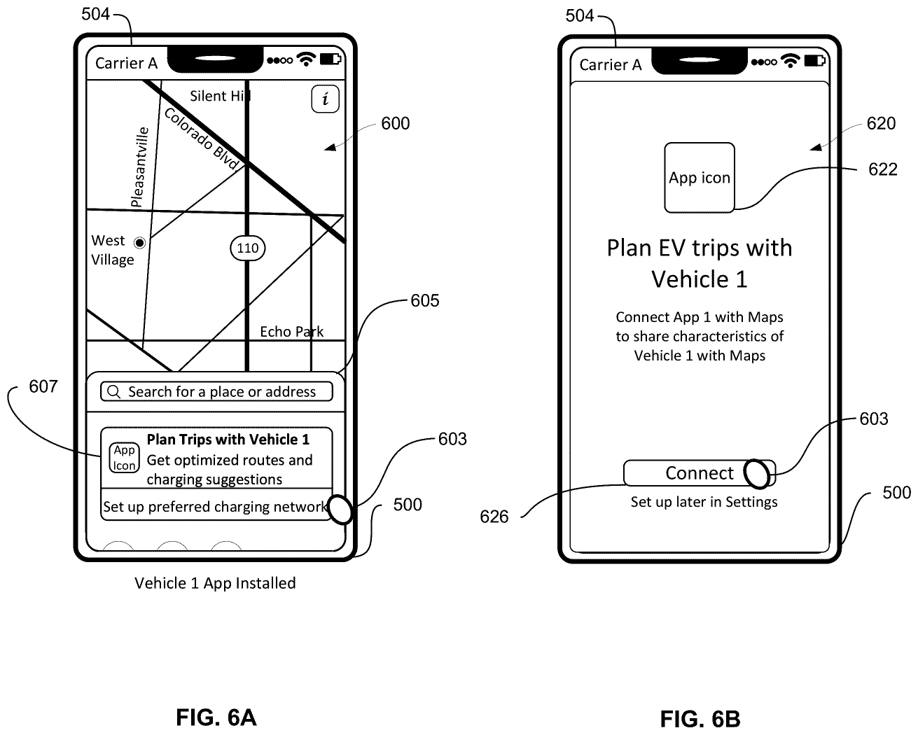

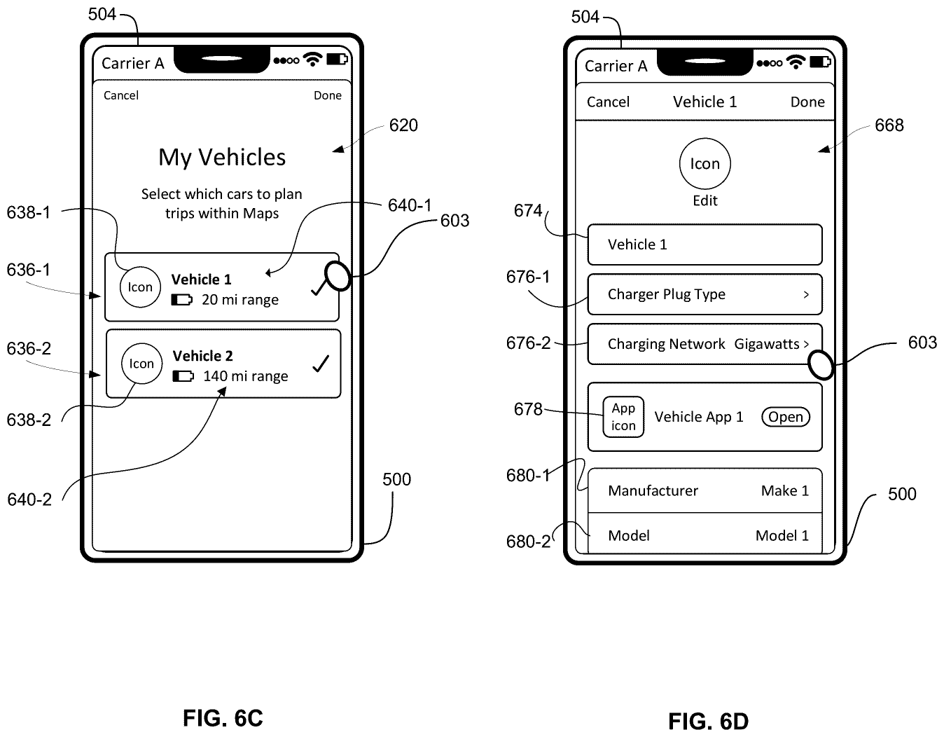

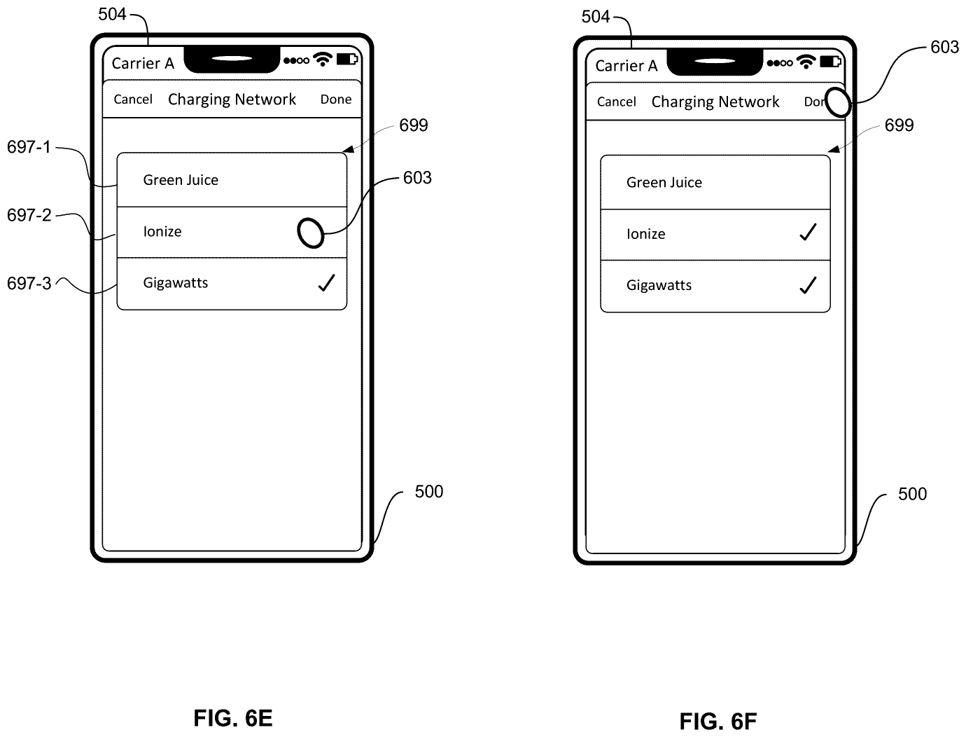

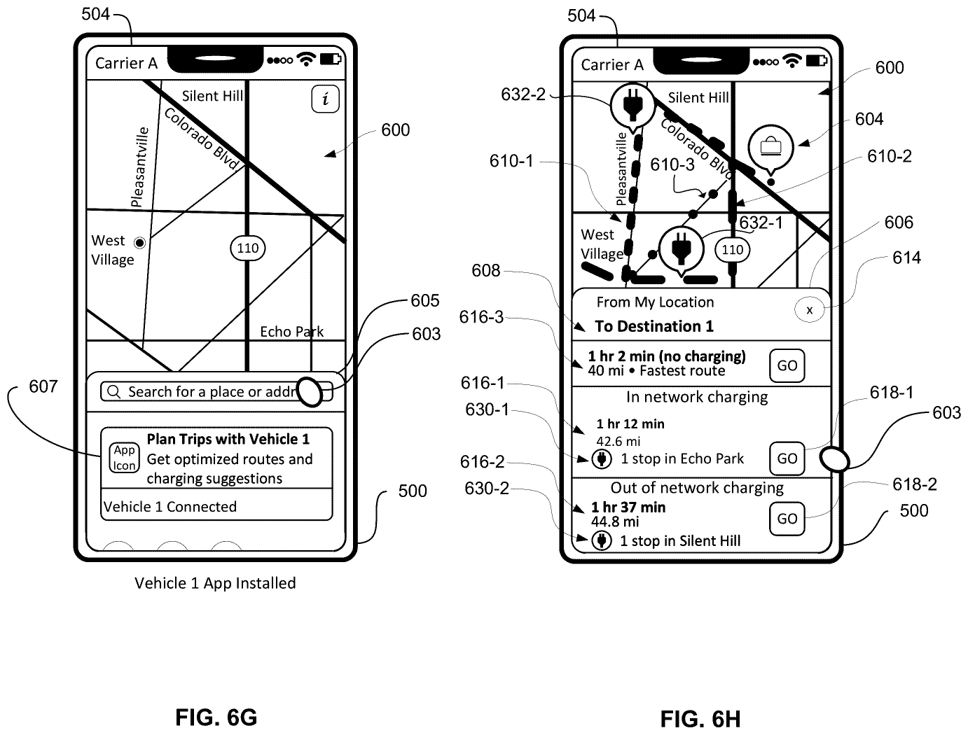

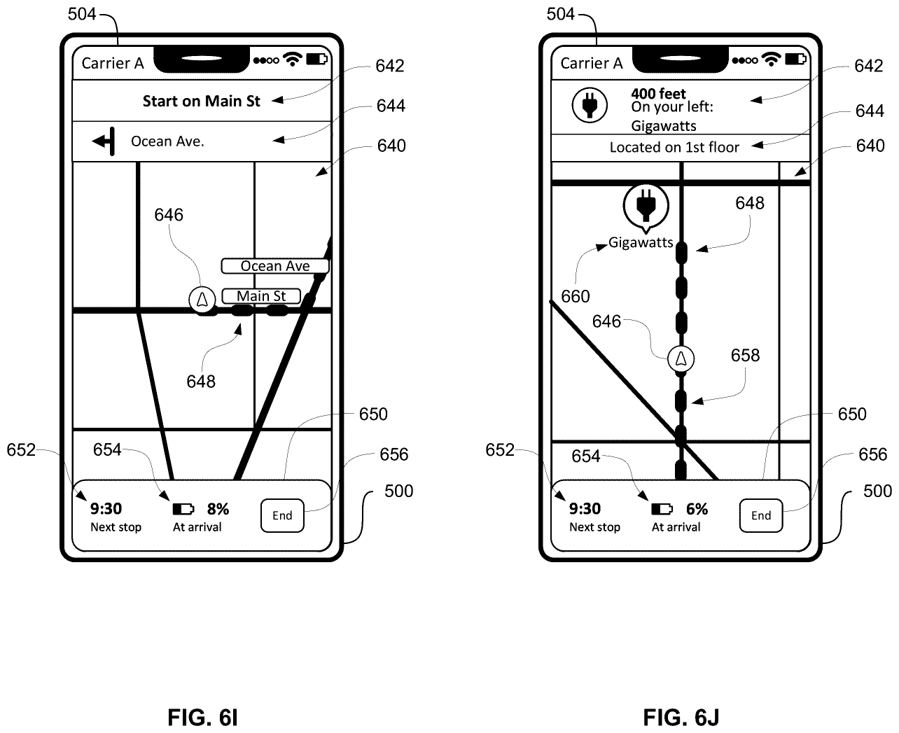

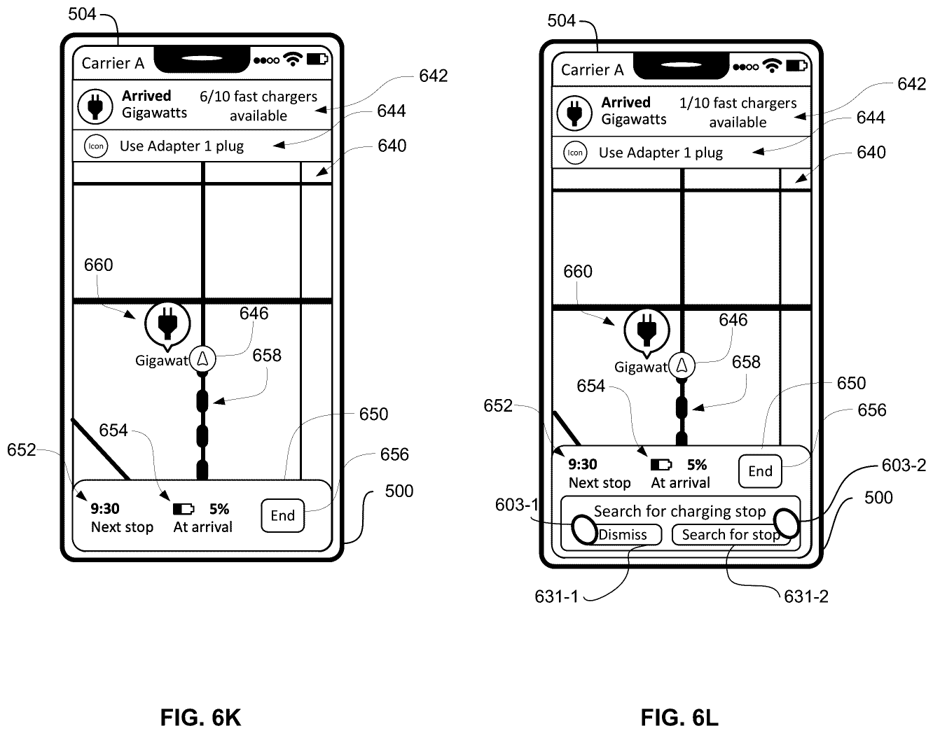

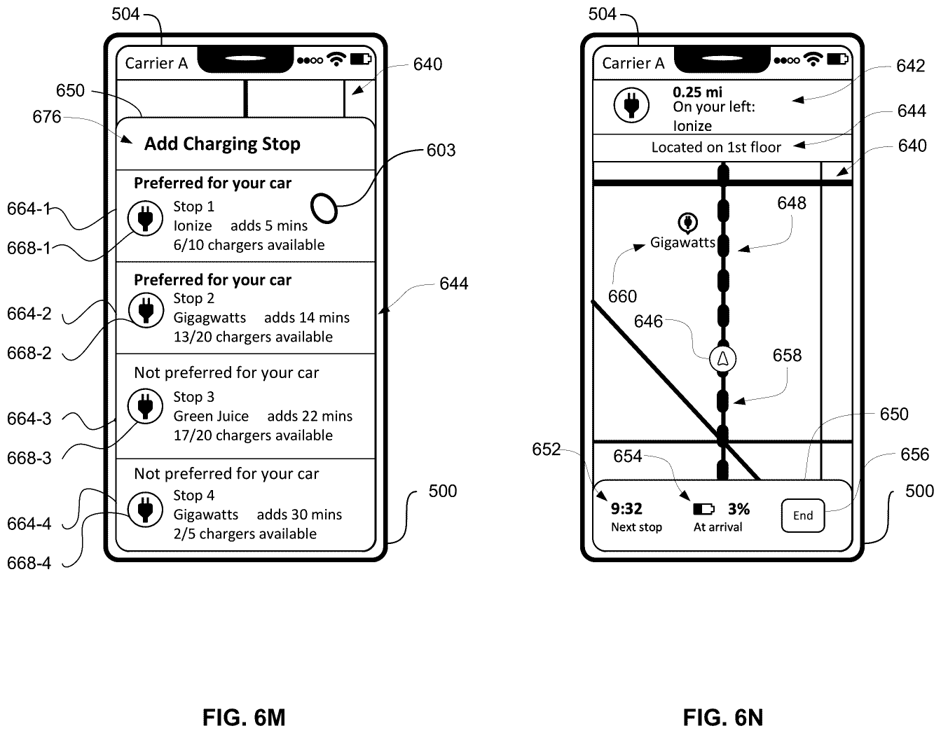

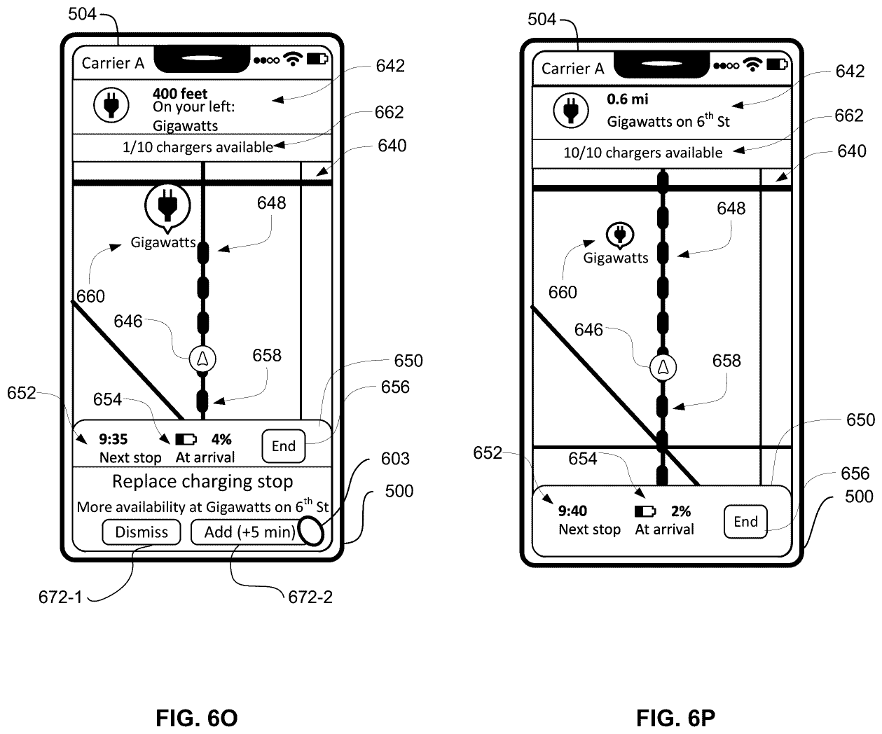

FIGS. 6A-6P illustrate exemplary ways in which electronic devices present navigation routes in accordance with user preferences and/or based on a vehicle associated with the user (and/or the user's device), in accordance with some embodiments of the disclosure. It is understood that embodiments described herein with reference information being provided via a maps application, in accordance with a user account, and/or provided from the user account are merely exemplary. In some embodiments, such information is provided by an additional or alternative one or more sources, such as from a vehicle, from a computing device such as a server, and/or from the electronic device not using the maps application. In some embodiments, information such as routes and/or one or more user preferences are provided by an additional or alternative one or more sources, such as from the vehicle, from the server, and/or from the electronic device not using the maps application and/or not using a user account associated with the electronic device. The embodiments in these figures are used to illustrate the processes described below, including the processes described with reference to FIG. 7.

FIG. 6A-6P illustrate an electronic device 500 associated with a user account, including a display generation component 504—such as a touch screen including a display-configured to provide one or more navigation directions using a maps application. In some embodiments, user interface 600 is a user interface of a map application (e.g., an application in which a user is able to view geographic locations, search for locations, and/or request navigation directions from one location to another). In some embodiments, the map application is an application installed on device 500. It is understood that embodiments described with reference to location(s) and/or stop(s) optionally also apply to embodiments described with reference to destination(s). In some embodiments display generation component 504 includes a touch screen configured to detect one or more contacts with a surface of the touch screen, the one or more contacts operative to select visual indications and/or visual representations such as buttons and icons presented within user interface 600 and/or via display generation component 504.

In some embodiments, the map application optionally presents maps, routes, location metadata, and/or imagery (e.g., captured photos) associated with various geographical locations, and/or points of interest. The map application optionally obtains map data that includes data defining maps, map objects, routes, points of interest, and/or imagery from a navigation server. For example, the map data can be received as map tiles that include map data for geographical areas corresponding to the respective map tiles. The map data optionally includes, among other things, data defining roads and/or road segments, metadata for points of interest and other locations, three-dimensional models of the buildings, infrastructure, and other objects found at the various locations, and/or images captured at the various locations. The map application optionally requests from a navigation server through a network (e.g., local area network, cellular data network, wireless network, the Internet, and/or wide area network) map data (e.g., map tiles) associated with locations that device 500 frequently visits. The map application optionally stores the map data in a map database. The map application optionally uses the map data stored in the map database and/or other map data received from device 500 to provide the map application features described herein (e.g., display of customized navigation routes).

In some embodiments, the navigation server optionally is a software server configured to obtain, generate, and/or store map data. For example, the navigation server optionally obtain(s) a Light Detection and Ranging (Lidar) generated point cloud (e.g., points that define locations of surfaces of objects in the vicinity of an image capture location) for various locations included in the map data. The navigation serve optionally generates a three-dimensional model (e.g., three-dimensional mesh) for each of the various locations using the respective point clouds for the locations. The navigation server optionally obtains images captured at the various locations (e.g., capture locations) and use the images to add texture to the three-dimensional model thereby generating a photorealistic three-dimensional image representing the corresponding location. For example, the captured images (e.g., photographs, and/or panorama photographs) optionally are stretched over the surfaces of the three-dimensional model for a particular location to generate a photorealistic three-dimensional view of the particular location. The three-dimensional models and textures (e.g., captured images, stretched images, and/or images applied to the three-dimensional model) optionally are stored in a map database on the navigation server and served to user devices (e.g., device 500) to provide the various features and functions described herein. The navigation server optionally is configured to obtain, generate, and/or store other map data in the map database.

It is understood that although the description of the figures below describes embodiments in which device 500 determines one or more proposed routes and/or determines one or more suggested destinations, this determination optionally is performed by the navigation server or by a combination of device 500 and the navigation server, the results of which are provided to device 500 for display in a user interface via a display generation component of device 500.

In FIG. 6A, user interface 600 displayed via display generation component 504 includes a representation of a map. For example, in FIG. 6A, user interface 600 includes representations (e.g., textual and/or graphical presentations) associated with particular geographic location, including representations of roads, landmarks, businesses, and/or buildings. Concurrently, user interface 600 includes information 605, which includes one or more fields that are selectable to enter queries for destinations of navigation, and prompt 607. Prompt 607 includes information indicating that a user account associated with electronic device 500 (e.g., logged into) is associated with a vehicle and/or is not yet associated with a preferred fueling network of the vehicle, as described further with reference to method 700. In some embodiments, the prompt 607 includes and/or is a selectable option that is selectable to initiate a process to define an association between the user account associated with the electronic device and a selected one or more preferring fueling or charting networks. User input 603—corresponding to a touch input directed to a touch screen, but understood as representative as one or more inputs and/or one or more modalities of inputs, such as voice commands and/or air gestures described further with reference to method 700—is received selecting prompt 607 in FIG. 6A. In some embodiments, in response to user input 603 in FIG. 6A, device 500 initiates a process to link Vehicle 1, (e.g., through the Vehicle 1 app) with the map application, such as shown from FIG. 6A to FIG. 6B.

From FIG. 6A to FIG. 6B, device 500 displays user interface 620. In some embodiments, user interface 620 is a user interface for confirming linking of Vehicle 1 (e.g., through the Vehicle 1 App) with the map application. In some embodiments, user interface 620 includes an icon 622 that represents the Vehicle 1 app (e.g., the app icon). In some embodiments, user interface 620 includes description that explains that connecting Vehicle 1 (e.g., through the Vehicle 1 App) with the map application allows the map application to receive characteristics of Vehicle 1. In some embodiments, user interface 620 includes button 626 that is selectable to connect (e.g., add, link, and/or register) Vehicle 1 with the map application. It is understood that in some embodiments, the linking is facilitated entirely by the maps application, without requiring additional communication with another application (e.g., the Vehicle 1 App).

In some embodiments, electronic device 500 is associated with Vehicle 1 without performing one or more operations described with reference to FIGS. 6A-6G. For example, electronic device 500 and/or circuitry included in Vehicle 1 optionally detect an event linking electronic device 500 and Vehicle 1, such as a moving of electronic device 500 within a threshold distance of circuitry (e.g., RFID circuitry) included in Vehicle 1 (e.g., 0.001, 0.01, 0.1, 1, 10, or 100 m), a contacting of electronic device 500 with a housing and/or surface of circuitry included in Vehicle 1, a wired connection made between electronic device 500, a wireless discovery and linking initiated at electronic device 500 and/or Vehicle 1 (e.g., while electronic device 500 and Vehicle are within a threshold distance of one another, or outside the threshold distance facilitated by longer range communication protocols and/or via intermediate computing devices such as one or more servers), and/or a linking between electronic device 500 and Vehicle 1 using another device, such as one or more servers. After the linking is successfully completed, electronic device 500 optionally performs one or more operations described with reference to FIG. 6G-6P using information provided during the linking process and/or from electronic device 500 and/or Vehicle 1, optionally without using information furnished via a user account as described with reference to FIGS. 6A-6F. In some embodiments, the linking between electronic device 500 and Vehicle 1 is temporary. In FIG. 6B, electronic device 500 detects user input 603 selecting button 626.

From FIG. 6B to FIG. 6C, in some embodiments, in response to receiving user input 603 in FIG. 6B, device 500 updates user interface 620. In some embodiments, user interface 620 includes one or more vehicles that are associated with the Vehicle 1 App (e.g., the application for which icon 622 was displayed in FIG. 6B). For example, a particular vehicle application can be associated with multiple vehicles and receive and provide information about multiple vehicles (e.g., if the vehicles are of the same make and model, if the vehicles are by the same manufacturer, if the application is compatible with multiple vehicles, if the application is compatible with vehicles of different makes and/or models). In some embodiments, respective vehicles are associated with respective vehicle applications that are linked to the maps application. The embodiments contemplated herein are described with reference to a single application that is associated with multiple vehicles, but it is understood that description of such embodiments apply to embodiments where different vehicles are associated with respective vehicle applications. In FIG. 6C, user interface 620 includes listing 636-1 corresponding to Vehicle 1 and listing 636-2 corresponding to Vehicle 2. In such embodiments, the Vehicle 1 App is able to access and provide information about Vehicle 1 and Vehicle 2 (e.g., Vehicle 1 and Vehicle 2 are optionally the same make and/or model and/or both Vehicle 1 and Vehicle 2 are registered with the Vehicle 1 app). Additionally or alternatively, two different vehicle applications are able to access and provide information about Vehicle 1 and Vehicle 2, respectively, via respective vehicle applications associated with each vehicle. As shown in FIG. 6C, listing 636-1 includes icon 638-1 representing Vehicle 1 and description 640-1. In some embodiments, description 640-1 includes the name of the vehicle (or optionally the make and/or model of the vehicle) and the current charge status of Vehicle 1 (and optionally the current estimated driving range). Similarly, listing 636-2 includes icon 638-2 representing Vehicle 2 and description 640-2 that includes the name of Vehicle 2 and the current charge status of Vehicle 2 (and optionally the current estimated driving range). The names of the vehicles and the current charge statuses are optionally received from the Vehicle 1 app. In some embodiments, each listing includes an indication indicating that the respective vehicle will be added and/or has been previously added to the map application.

In some embodiments, user interface 620 includes an indication of a current vehicle. For example, listing 636-1 optionally includes a visual indication such as text and/or an icon illustrating that Vehicle 1 is a current vehicle. Additionally or alternatively, user interface 620 optionally includes a different vehicle (e.g., Vehicle 3) that is a current vehicle. In some embodiments, the current vehicle is used to indicate one or more preferred charging networks, provide information to the maps application, and/or provide user settings to indicate preferences to the maps application. In some embodiments, the current vehicle is detected in accordance with the linking of electronic device 500 described previously with reference to FIG. 6A (e.g., if the current vehicle is detected as proximate to electronic device 500), and the one or more operations expressly establishing a current vehicle and/or setting up a vehicle used to inform navigation directions illustrated with reference to FIGS. 6A-6F are omitted, and electronic device 500 uses one or more user preferences associated with the current vehicle.

In FIG. 6C, user input 603 is received selecting affordance listing 636-1 corresponding to a confirmation to add and/or modify a configuration of settings associated with Vehicle 1. In some embodiments, in response to user input directed to listing 636, Vehicle 1 is added to the map application and the Vehicle 1 app is linked with the map application. In some embodiments, linking the Vehicle 1 app allows the map application to receive information about Vehicle 1 from a source external to the application. In some embodiments, the information is received from the Vehicle 1 app. In some embodiments, the information is received from a server external to device 500 (e.g., linking the Vehicle 1 app with the map application provided the map application with information and/or credentials to communicate with the external server).

It is understood that the above-described process of providing an indication to link the Vehicle 1 app with the map application can be repeated for multiple applications that are associated with other vehicles. For example, in the embodiments described above, the Vehicle 1 app is associated with Vehicle 1 and Vehicle 2. In addition to the Vehicle 1 app, device 500 can have a Vehicle 3 app installed that is associated with Vehicle 3. In such embodiments, an indication can be displayed for linking the Vehicle 3 app with the map application (e.g., to add Vehicle 3 to the map application and enable the map application to receive information about Vehicle 3 from the Vehicle 3 app and/or an external source). In other embodiments, the previously described indication is only displayed for one application associated with a vehicle (e.g., only displayed once) and after performing the above-described linking process, a user can manually initiate the process for other vehicle applications via a settings user interface of the map application (e.g., such as user interface 668 described below).

As shown in FIG. 6C, user interface 620 includes listing 636-1 corresponding to Vehicle 1 that was added according to the linking process described above. In some embodiments, user interface 620 includes listings of vehicles that were added to the map application via a process other than the process to link the map application with an application associated with a vehicle. In FIG. 6C user input 603 is received selecting listing 636-1. In some embodiments, in response to user input 603 in FIG. 6C, device 500 displays user interface 668 in FIG. 6D. in FIG. 6D, user interface 668 corresponds to a settings user interface for Vehicle 1. In some embodiments, user interface 668 includes name field 674. In some embodiments, name field 674 is selectable to edit the name of Vehicle 1 (e.g., cause display of a soft keyboard with which the user is able to edit and/or provide a desired name). In some embodiments, name field 674 is pre-populated with a name provided by the Vehicle 1 app (e.g., the make and/or model of the car and/or a name selected by a user to the Vehicle 1 app). In some embodiments, user interface 668 includes charger option 676-1 and charger option 676-2. Charger option 676-1 corresponds to the charging plug type of Vehicle 1 and is selectable to view and/or edit the charger types and/or available adapters, as will be described in more detail below. In some embodiments, charger option 676-2 corresponds to the charging network preference and/or compatibility with Vehicle 1, and is selectable to view and/or edit the charging networks to charge Vehicle 1 with, as will be described in more detail below.

In some embodiments, user interface 668 includes app listing 678 corresponding to the application that is associated with Vehicle 1 (e.g., and linked with the map application). In some embodiments, selection of app listing 678 causes display of the application associated with Vehicle 1. In some embodiments, user interface 668 does not include app listing 678 if Vehicle 1 was added via a process other than the app linking process described above (e.g., such as via manually adding the vehicle).

In some embodiments, user interface 668 includes manufacturer information 680-1 and model information 680-2 that includes information about the make and model of Vehicle 1, respectively. In some embodiments, the make and/or model information of Vehicle 1 is received from the Vehicle 1 app and thus manufacturer information 680-1 and model information 680-2 is automatically populated upon linking the Vehicle 1 app with the map application. In some embodiments, such information is populated in response to and based on the linking described previously with reference to FIG. 6A. In some embodiments, the information is provided from additional or alternative sources other than the Vehicle 1 app, such as from a current vehicle that is linked to electronic device 500.

In FIG. 6D, user input 603 is received selecting charger option 676-2 corresponding to charging networks. In some embodiments, the selected vehicle is an at least partially electrically powered vehicle (e.g., an “EV”), compatible with one or more charging standards and chargers supporting the one or more standards. In some embodiments, in response to user input 603 in FIG. 6D, device 500 displays user interface 699, as shown in FIG. 6E. In some embodiments, user interface 699 includes a list of one or more charging networks that are in operation in the user's geography (e.g., in the country, in the state, in the municipality, and/or in the region). In FIG. 6E, user interface 699 includes charging network 697-1, charging network 697-2, and charging network 697-3. As shown in FIG. 6E, charging network 697-3 is automatically initially populated, optionally based on information received from the vehicle, Vehicle 1 App, from another informational source such as another application other than the maps application, and/or electronic device 500, and/or via the maps application. For example, Vehicle 1 may have a pre-existing relationship with charging network 697-3 and/or may be compatible with charging network 697-3 (e.g., optionally only compatible with charging network 697-3), described further with reference to method 700. In some embodiments, charging network 697-3 is the charging network recommended by the manufacturer of Vehicle 1. As shown in FIG. 6E, a user is able to select any of the charging network listings to indicate to the map application the charging network that the user would like to use to charge Vehicle 1. In FIG. 6E, user input 603 is received selecting charging network 697-2. In response to selection of charging network 697-2, the map application will suggest destinations including charging stops for Vehicle 1 that are within charging network 697-2 (e.g., selection of a charging network selects the respective charging network as the only compatible charging network). In some embodiments, in response to selection of charging network 697-2, the map application will suggest charging stops for Vehicle 1 that are within both charging network 697-2 and charging network 697-3 (e.g., selection of a charging network toggles the respective charging network as a compatible charging network).

In some embodiments, if the respective vehicle is not an electric vehicle, but rather, a vehicle of a different fuel type (e.g., gasoline vehicle, plug-in hybrid, and/or E85 vehicle), then charger option 676-2 in FIG. 6D optionally is not displayed on user interface 668, or user interface 699 includes options for networks of stations compatible with the respective vehicle's fuel type (e.g., options corresponding to different gas station brands). For example, for a gas vehicle, user interface 699 can include options of different gas station brands that are selectable such that the map application will only suggest gas stations of the selected gas station brands. In FIG. 6E, in response to detecting user input selecting charger option 676-2, electronic device 500 toggles and enables a corresponding charging network (e.g., “Ionize”) as illustrated by the checkmark in FIG. 6F. In FIG. 6F, user input 603 is detected that corresponds to a selecting of a selectable option to close the vehicle settings user interface.

In FIG. 6G, after receiving input to close the vehicle settings user interface, the electronic device 500 displays the maps user interface 600. In the maps user interface 600, prompt 607 is updated to no longer request user input to establish a preferred charging network, because the preferred charging network(s) have been automatically and/or manually selected, as described with reference to the previous figures. In some embodiments, when displaying the maps user interface 600 and in accordance with a determination that the preferred charging network is established with the user account, electronic device 500 forgoes display of prompt 607. In some embodiments, prompt 607 is updated based on a linking between electronic device and a current vehicle as described previously at least with reference to FIG. 6A, no longer request the user input to establish the preferred charging network because an information source such as a currently connected vehicle and/or a vehicle in proximity to electronic device 500 has provided such a preferred charging network or networks. In some embodiments, a user is able to search for a respective place or address. For example, in response to detecting user input 603 in FIG. 6G, electronic device 500 initiates a process to search for a destination and/or display one or more proposed routes toward a selected destination, such as shown in FIG. 6H.

In some embodiments, the map application searches through a map database for locations (e.g., places) that match the search criteria (e.g., for Destination 1). The map application can send a request to a navigation server to cause the navigation server to search for locations that match the search criteria. After obtaining map data corresponding to the search criteria, the map application can present a list of places that match the search criteria and/or the user may select one of the places to cause the place (e.g., address, point of interest, and/or landmark and/or) to be presented on user interface 600. For example, in response to user input 603 in FIG. 6G, a soft keyboard is displayed via display generation component 504, and in response to typing in a destination, electronic device 500 optionally displays one or representations of destination search results. In response to detecting a selection (e.g., of a particular search result and/or a button on the soft keyboard), one or more proposed routes toward the selected destination are displayed, such as shown in FIG. 6H.

In FIG. 6H, user interface 600 is updated to display a plurality of proposed routes toward the destination selected between FIGS. 6G and 6H. FIG. 6H illustrates several possible types of routes that are optionally presented based on the previously established preferred charging network. As described previously, in some embodiments, the preferred charging network is established based on a currently selected vehicle via the user account. In some embodiments, a current vehicle that is communicatively coupled to electronic device 500 supersedes the vehicle selected in the user account, such as a vehicle electronic device 500 is communicatively coupled to (wired or wirelessly), and/or user settings associated with the current vehicle such as a preferred charging network are otherwise use in place of similar user settings specified in the user account. In some embodiments, the plurality of proposed routes are additionally or alternatively determined in accordance with charging preferences associated with the current vehicle, information about the current vehicle, traffic information along regions prospective routes, distance-based preferences associated with the prospective routes, and one or more user preferences (e.g., specified via the user account or another informational source) such as avoiding highways and/or toll roads.

In some embodiments, electronic device 500 determines characteristics of candidate routes to arrive at the destination, and presents one or more of the candidate routes as the plurality of proposed routes based on factors associated with the candidate routes. For example, electronic device 500 optionally determines a first set of candidate routes in accordance with one or more routing algorithms, and optionally ranks the first set of candidate routes. The ranking of the first set of candidate routes is optionally based on one or more factors, such factors relating to how long it takes to traverse and/or charge along the route, to what degree the route minimizes changes in navigation directions (e.g., turning, entering and/or exiting freeways, entering toll roads, and/or entering/exiting charging stops), and/or based on scenic qualities of the views and/or landmarks along the route. In some embodiments, the ranked candidate routes are displayed by electronic device 500 as the plurality of proposed routes. In some embodiments, one or more of the ranked routes are not displayed in accordance with a determination that the ranking of the respective route is past a threshold ranking (e.g., displaying the first, second, and/or third routes having the highest levels of compatibility between the ranking criteria and user preferences, and forgoing display of the fourth highest, fifth routes). In some embodiments, candidate routes including charging stops lacking compatible characteristics associated with a vehicle in communication with electronic device 500 (e.g., a compatible charging standard and connector type) are not included and/or removed from the candidate routes.

In some embodiments, the ranking of candidate routes is at least initially independent of charging considerations. In some embodiments, in response to ranking the above routes and before displaying the plurality of proposed routes, the ranked candidate routes are again evaluated in accordance with charging preferences of the user—as described herein—and/or charging availability along the candidate routes, electronic device 500 further changing the rankings in light of the evaluation of charging preferences. In some embodiments, electronic device 500 displays the re-ranked candidates as the plurality of routes. In some embodiments, electronic device 500 optionally obtains information (e.g., historical traffic data, elevation data, and/or current traffic data) such as from manufacturers of vehicles, and determines the candidate routes in accordance with the information. For example, a manufacturer of the vehicle associated with electronic device 500 optionally provides information that a first candidate route is historically less trafficked than a second candidate route at an estimated time electronic device 500 will navigate the first and/or second candidate routes. In accordance with the information, electronic device 500 optionally ranks the first candidate route as relatively preferred over the second candidate. Additionally, the manufacturer optionally provides first elevation information associated with elevation changes along a first candidate route, and optionally provides second elevation information associated with elevation changes along a second candidate route, different from the first candidate route. In some embodiments in accordance with the first information and the second information, electronic device determines that an estimated amount of time and/or an estimated amount of battery consumption required to traverse the second route is greater than an amount of time and/or estimated amount of battery consumption required to traverse the first route, and accordingly ranks the first candidate route as the second candidate route due to the lower opportunity cost of navigating along the first candidate route. Although determinations and operations concerning the candidate routes are described with reference to electronic device 500 making such determinations and performing such operations, it is understood that additional or alternative devices-such as computer systems included and/or in communication with the vehicle and/or server computers-optionally are able to additionally or alternatively make such determinations and/or perform such operations without departing from the scope of the disclosure.

In some embodiments, when one or more batteries included in the vehicle associated with the electronic device 500 have capacity to charge and/or does not have enough charge to reach the final, selected destination of the proposed route, a first proposed route is presented including at least a first destination associated with the preferred charging network, such as a first charging station of a first charging network. The electronic device 500 optionally presents the first proposed route, because the first preferred charging network optionally presents a cost savings (e.g., due to a subscription) and/or because the first preferred charging network includes chargers that support a charging standard compatible with the vehicle. For example, first proposed route 610-2 corresponding to listing 616-1 includes a first stop 630-1 corresponding to representation 632-1 on a representation of a map in user interface 600. First stop 630-1 optionally is included to ensure the vehicle reaches the final destination, represented by indication 604 (e.g., “Destination 1” included in textual indication 608).

In some embodiments, when the one or more batteries included in the vehicle associated with the electronic device 500 have sufficient capacity to reach the final destination without stopping to charge, a second proposed route is presented not including a respective charging stop. For example, second proposed route 610-3 corresponding to listing 616-3, indicated to be the fastest route due to the lack of a charging stop, is presented by electronic device 500. In some embodiments, a portion of the second proposed route 610-3 is the same as a portion of another proposed route, such as the portion of first proposed route 610-2 shown in FIG. 6H along a street (e.g., “Colorado Blvd”) near indication 604 of Destination 1. In some embodiments, in accordance with a determination that the one or more batteries lack sufficient capacity to reach the final destination, electronic device 500 forgoes display of listing 616-3 and the corresponding representation of the route.

In some embodiments, the proposed routes include a third proposed route including a charging station outside of the preferred charging networks described with reference to FIGS. 6E-6F and method 700. For example, third proposed third 610-1 includes a stop 630-2 as indicated by representation 632-2 and illustrated in listing 616-2. Listing 616-2 includes information conveying that the third proposed route 610-1 does not include one or more charging stops that are within the preferred network (e.g., “Out of network charging” in listing 616-2). For example, stop 630-2 optionally correspond to a charger of a different network (e.g., “Green Juice” in FIG. 6F). In some embodiments, in accordance with a determination that the preferred charging network corresponds to the network associated with stop 630-2 (e.g., to “Green Juice” instead of “Ionize” and “Gigawatts” in FIG. 6F), listing 616-2 is modified to include information describing that route 610-1 is within the preferred charging network of a user account of the electronic device 500 and/or is otherwise preferred based on user-specified settings and/or settings tied to a current vehicle that electronic device 500 is in communication with. Because in such an embodiment, first proposed route 632-1 does not include a charging stop associated with the preferred charging network, listing 616-1 is optionally modified to describe that route 610-2 does not correspond to the preferred charging network of the user account and/or preferred based on user-specified settings.

In some embodiments, in accordance with a determination that the electronic device will reach the ultimate destination of the proposed routes with a level of charge of one or more batteries included in a vehicle in communication with electronic device 500, that is less than a first threshold level of charge (e.g., 10, 20, 30, 40, or 50% charge), electronic device 500 presents a first route and a second route. The first route optionally includes one or more charging stops, such that the estimated level of charge of the vehicle's one or more batteries is estimated to be greater than the first threshold level of charge, and the second route optionally does not include one or more respective charging stops, such that the estimated level of charge of the vehicle's one or more batteries is estimated to be above a second threshold level of charge (e.g., 1, 3, 5, 7, 10, 12, or 15%), that is less than the first threshold level of charge when arriving at the ultimate destination. In some embodiments, electronic device 500 displays information indicating that the second route will potentially represent a higher risk of reaching a low-charge state of the one or more batteries. In some embodiments, the one or more charging stops included in the first route are determined independently of one or more of the user's preferences, such as independently of a preferred charging network associated with electronic device 500. For example, a respective charging stop of the one or more charging stops are optionally compatible with the vehicle associated with electronic device 500 (e.g., via a charging connector of the vehicle), and/or is not included in a preferred charging network of electronic device 500.

In some embodiments, in accordance with a determination that the user has not established a preferred charging network, the electronic device 500 optionally displays one or more routes different than those illustrated in FIG. 6H, and/or optionally displays one or more routes that are the same as those illustrated in FIG. 6H. For example, listing 616-3 is optionally included, and/or first proposed route 610-2 is optionally included in a plurality of proposed routes presented in accordance with a determination that the user's account is not associated with a preferred charging network, and/or second proposed route 610-1 and listing 616-2 are optionally not displayed by electronic device 500. In some embodiments, listing 616-1 corresponding to first proposed route 610-2 includes indication 630-1 that indicates that suggested route 610-2 includes one stop (e.g., one destination) in Echo Park (e.g., the name of the region at which the charging station is located). In some embodiments, listing 616-2 corresponding to second proposed route 610-1 includes indication 630-2 that indicates that second proposed route 610-2 includes one stop in Silent Hill. In some embodiments, second proposed route 610-2 does not include a representation or icon of a suggested stop even though second proposed route 610-2 does include a suggested stop. In some embodiments, only the first listed (e.g., most recommended route and/or a route that is currently selected or highlighted) suggested route includes icons of suggested stops and other suggested routes do not include an icon of suggested stops even if the suggested route includes suggested stops (e.g., any or all of the other suggested stops). In some embodiments, all displayed suggested routes include an icon or indication of suggested stops (e.g., and not just the first suggested route). For example, the indication (e.g., icon) of the suggested stop 632-2 is a representation of an electric vehicle charging station and is a different icon than a suggested that is a representation of an alternative fuel station, such as a gas station. In some embodiments, the icon representing a suggested stop along a route is the same regardless of whether the suggested stop is an electric vehicle charging station or a gasoline station. In FIG. 6H, input 603 is an input that selects listing 616-1 corresponding to first proposed route 610-2. In some embodiments, in response to user input 603 in FIG. 6H, device 500 displays user interface 640 as shown in FIG. 6I.

In some embodiments, in response to the user input 603 in FIG. 6H, the electronic device 500 displays a representation of a plurality of steps corresponding to a plurality of navigation directions along the first proposed route 610-2 in FIG. 6I. For example, the navigation directions include one or more step-by-step directions for travelling from a current location corresponding to the electronic device 500 and/or a selected starting location of device 500 to Destination 1 via first proposed route 610-2. In some embodiments, one or more of the steps of navigation directions include an indication of an amount of charge that an electric vehicle is estimated to have when the vehicle and/or the location corresponding to the electronic device 500 reaches the location of the respective step (e.g., if the vehicle is following the route as planned). In some embodiments, a respective representation of a respective step of the navigation directions includes information about the estimated remaining level of charge of the vehicle when the vehicle will reach the respective step (e.g., an estimated percentage charge, a color-coded icon and/or text (e.g., green, yellow, or red for relatively high, moderate, and low levels of estimated charge at the respective step, respectively), and/or information about time(s) associated with charging such as an amount of time required to charge one or more batteries of the vehicle to a displayed level of charge).

In some embodiments, such as in FIG. 6I, a navigation mode is initiated in response to user input 603 in FIG. 6H, including displaying step-by-step and/or turn-by-turn directions to travel along a respective route using a selected route as a determine route for navigation directions. In some embodiments, the step-by-step and/or turn-by-turn directions are provided based on the location of the device to provide the user with live directions to reach the destination. In FIG. 6I, user interface 640 includes instructions 642 and instructions 644. In some embodiments, instructions 642 includes textual instructions corresponding to the currently displayed step. For example, in FIG. 6I, instructions 642 instruct the user to begin driving on Main St. In some embodiments, instructions 644 provide additional instructions associated with the displayed step or provides a preview of the next step. For example, in FIG. 6I, instructions 644 indicate that the next step is to turn left on Ocean Ave. As shown in FIG. 6I, any of instructions 642 and/or 644 can include an icon representative of the step (e.g., a turn icon and/or a start icon). In some embodiments, instructions 644 are not displayed for certain steps or for all steps (e.g., if additional information is not necessary).

In some embodiments, user interface 640 includes a representation of the map that includes the current position of device 500, illustrated by location indicator 646 in FIG. 6I. As shown in FIG. 6I, location indicator 646 indicates the current position of device 500 (e.g., is located on the representation of the map corresponding to the current location of device 500) and/or the orientation of device 500 (e.g., the arrow in location indicator 646 is facing in the direction of the orientation of device 500). In some embodiments, user interface 640 includes route indication 648 corresponding to suggested route 610-2. In some embodiments, the representation of the map is oriented such that the map is facing the direction that device 500 is facing. For example, in FIG. 6I, if device 500 is facing south, then the representation of the map is oriented such that south is upwards.

In some embodiments, user interface 640 includes user interface 650 that is displayed overlaid over user interface 640. In some embodiments, user interface 650 provides general information of suggested route 610-2. For example, in FIG. 6I, user interface 650 includes indication 652, indication 654, and button 656. In some embodiments, indication 652 displays the estimated time of arrival at the next stop (e.g., the suggested stop (e.g., an intermediate destination), the final destination, and/or a user-selected stop along the suggested route). In some embodiments, indication 654 displays the estimated amount of charge that the vehicle will have upon arrival at the next stop. In some embodiments, button 656 is selectable to end navigation mode (e.g., to stop providing step-by-step or turn-by-turn instructions to reach the destination).

FIG. 6J illustrates an embodiment in which the user has traveled along suggested route 610-2 and is approaching the suggested charging stop along suggested route 610-2 shown in FIG. 6H, such as a first destination. In some embodiments, device 500 determines that the user has traveled along suggested route 610-2 and is approaching the suggested charging stop (e.g., suggested stop 632-1 from FIG. 6H, represented by representation 660) using one or more device location mechanisms or processes (e.g., using a GPS locator on device 500). In FIG. 6J, instructions 642 are updated to indicate that the suggested charging stop is 400 feet ahead and on the left side of the road. In some embodiments, instructions 644 is updated to provide additional information about the suggested charging stop (e.g., that the charging station is located on the first floor). In some embodiments, if the suggested stop is to refuel at a gasoline station (e.g., for a gasoline vehicle), instructions 644 can be updated to provide additional information about the gasoline station (e.g., which pump to use, which grade of gas to use, where the pumps are located). As described previously, representation 660 is included in a first preferred charging network (e.g., “Gigawatts”) of the user account of electronic device 500.

In some embodiments, user interface 640 includes route indication 648 corresponding to the upcoming route. In some embodiments, user interface 640 includes route indication 658 corresponding to the route that was traversed. In some embodiments, between route indication 648 and route indication 658, a representation (e.g., indicator 646) of the current location of the user's vehicle is displayed. In some embodiments, user interface 640 includes representation 660 corresponding to the suggested stop (e.g., suggested stop 632-1 from FIG. 6H). In some embodiments, representation 660 is displayed at a location on the representation of the map corresponding to the location of the suggested stop. As shown in FIG. 6J, representation 660 is an icon of an electric vehicle charging station. In some embodiments, the icon corresponds to the preferred charging network, such as an icon of the preferred charging network. In some embodiments, representation 660 includes a textual description of the suggested stop (e.g., the name of the suggested stop, the name of the charging station, and/or the charging network associated with the charging station).

FIG. 6K illustrates an embodiment in which the user has arrived at the suggested charging stop (or optionally within a threshold distance from the suggested charging stop (e.g., 0.1, 1, 10, 100, 1000, or 10,000 m)) and a level of activity of the suggested charging stop is less than a threshold level of activity. In some embodiments, instructions 642 are updated to indicate that the user has arrived at the suggested stop. Instructions 642 additionally include an indication that six out of ten chargers included at the charging station are available. As described further with reference to method 700, in some embodiments, a level of activity of a destination corresponds to and/or includes a number and/or proportion of chargers (e.g., that are compatible with the vehicle) available to charge the vehicle. In some embodiments, instructions 644 is updated to suggest that the user use Adapter 1 to convert the plug used by the vehicle to a plug type that is compatible with the charging station. In some embodiments, determination that Adapter 1 is required to convert the plug type installed on the vehicle to a plug type that is compatible with the charging station is based on information received about vehicle. It is understood that providing information regarding required adapters can be applied to vehicles of other fuel types (e.g., gasoline vehicles, electric vehicles, hybrid vehicles, and/or plug-in hybrid vehicles).

In some embodiments, in accordance with a determination that the user has arrived, is within the threshold distance of the suggested charging stop, and/or will soon arrive and/or move to within the threshold distance of the suggested charging stop, electronic device 500 performs one or more operations to determine a current state of the suggested charging stop. For example, electronic device 500 initiates and/or communicates with a polling service to determine a level of activity and/or status of the charging stop. In some embodiments, in accordance with a determination that the activity level is greater than the threshold activity level, the electronic device 500 determines and/or suggests one or more replacement charging stops. The replacement route(s) from the current position of the user to the one or more replacement charging stops optionally is (are) determined such that the replacement route is relatively close in distance to the user's current position and/or comparable in charging speed (e.g., an estimated charging speed of replacement charging stops are within a threshold proportion (e.g., 1, 5, 10, 15, 20, or 25%) relative to the speed of the suggested charging stop). In some embodiments, the determining of the replacement route has one or more characteristics of the operations described with reference to the “candidate routes” described previously. In some embodiments, the determining of the replacement route forgoes consideration of one or more factors described with reference to the candidate routes that are determined at the outset of navigation towards a final destination of the route, such as forgoing consideration of a potential impact on total travel time to the final destination, and/or forgoing consideration of a distance of the replacement stop. In some embodiments, the replacement route does not include one or more charging stops that are already along a current route for which electronic device 500 is providing ongoing navigation (e.g., such candidate routes are discarded from the search for routes).

FIG. 6L illustrates an embodiment in which the user has arrived at the suggested charging stop, and a level of activity of the suggested charging stop is greater than a threshold level of activity. For example, instructions 642 indicate that one out of ten fast chargers are available for use. As an example, the remaining nine out of ten fast chargers are optionally, currently occupied, non-functional, and/or incompatible with the vehicle. Thus, the level of activity of the suggested stop (e.g., indicated by representation 660) is greater than a threshold level of activity, rendering the charging availability suboptimal to accommodate the vehicle due to a reduced speed of charge caused by the electrical load required to charge other vehicles. In some embodiments, in accordance with a determination that the activity level is greater than the threshold level of activity, the electronic device displays one or more selectable options to initiate a search to replace the initially suggested charging stop (e.g., a first destination) with a replacement charging stop (e.g., a second destination), described further with reference to method 700. For example, user interface 640 includes a first selectable option 631-2, that is selectable to initiate searching for one or more replacement charging stops, and a second selectable option 631-1, that is selectable to forgo initiation of the searching. In FIG. 6L, user input 603-1 including a selection of selectable option 631-1 is detected by electronic device 500, and in response, electronic device 500 forgoes the searching for replacement charging stop(s). In FIG. 6L, user input 603-2, including a selection of selectable option 631-2, is detected by electronic device 500, and is an alternative to user input 603-1. In response to detecting user input 603-1 in FIG. 6L, electronic device 500 optionally forgoes initiation of searching for replacement charging stops. In response to detecting user input 603-2 in FIG. 6L, electronic device 500 initiates and/or continues searching for replacement charging stop(s).

In FIG. 6M, in response to the user input 603-2 in FIG. 6L, user interface 650 is updated to including a plurality of prospective replacement charging stops. For example, listing 664-1 includes icon 668-1, corresponding to a preferred charging network of the user account and/or otherwise specified via user-specified settings (e.g., “Ionize” described with reference to FIG. 6F). Listing 664-1 includes information, such as text describing the charging network associated with charger(s) included at the listing 664-1, a number of currently available chargers and/or a number of available chargers that are estimated to be available at an estimated time of arrival of the user at the corresponding replacement charging station, and/or an estimate of additional time required to travel to the replacement station. In some embodiments, the information additionally includes an estimate of level of charge of the vehicle that one or more batteries of the vehicle will reach when the vehicle reaches the replacement destination. In some embodiments, the information is used by device 500 to sort the listings included in user interface 650, preferentially displaying replacement charging stops associated with preferred charging networks of the user account, from user-specified settings, and/or from vehicle-specified settings. For example, listing 664-1 and listing 664-2 are included at the top of the search results, because their respective associated charging networks are preferred by the user account. Listing 664-3 includes information similar to listing 664-1, however, is indicated that it is not preferred (e.g., “Not preferred for your car”) due to the potential impact on travel time (e.g., “adds 22 mins”), and/or due to being associated with a non-preferred charging network (e.g., “Green Juice”). Additionally, listing 664-4 includes information similar to listing 664-1, and is associated with a preferred charging network of the user account, specified via user-specified settings, and/or specified via vehicle-specified settings but is relatively far away (e.g., “adds 30 min”) and/or is relatively less available (e.g., “2/5 chargers available”), and thus not preferred. In some embodiments, a replacement charging stop associated with a preferred charging network is designated as not preferred, due to a level of activity at the replacement charging stop being greater than the threshold level of activity described previously. In some embodiments, listings 664 are respectively selectable to display a user interface corresponding to the selected destination. For example, a user interface card is optionally displayed corresponding to the selected replacement charging stop, including information describing characteristics of the destination, such as a number of chargers, a classification of the charging speeds of the chargers, a type of supported charging standards, a distance to the destination, availability of the one or more chargers, and/or one or more nearby points of interest (e.g., including pictures, text, and/or selectable options that are selectable to display additional user interfaces and/or to display the selected point of interest in the maps application user interface). In some embodiments, listings 664 are respectively selectable to initiate and/or continue process(es) to replace the initial charging station with the selected charging station. For example, user input 603 in FIG. 6M is detected, including a selection of listing 664-1. In some embodiments, in accordance with a determination that a preferred charging network of the user is different from the charging network associated with the user interface 650 presented in FIG. 6M, the electronic device 500 presents additional or alternative information. For example, in accordance with a determination that the preferred charging network is the “Green Juice” charging network, electronic device 500 optionally forgoes display of listing 664-1. Additionally or alternatively, in accordance with a determination that characteristics of the vehicle associated with electronic device 500 are different, electronic device 500 optionally displays additional, alternative, or the same listings 664, optionally with different respective information (e.g., charger availability) in accordance with the different characteristics of the vehicle. For example, in accordance with a determination that the vehicle has a first type of charging connector, listing 664-1 optionally presents first information (e.g., “6/10 chargers available”). In accordance with a determination that the vehicle has a second, different type of charging connector, listing 664-1 optionally presents second information based on a current status of the corresponding charging station (e.g., “3/5 chargers available”). It is understood that in view of such determinations associated with the characteristics of the preferred charging network, user preferences, and/or vehicles, the respective listings 664 optionally include additional or alternative listings (e.g., not displaying charging stations that do not have sufficient charging availability based on the vehicles connector type, displaying additional charging stations that are sufficiently available based on the connector type, and/or including or excluding listings based on the preferred charging network).

In FIG. 6N, in response to the selection of listing 664-1 in FIG. 6M, the charging stop 630-1 described with reference to FIG. 6H is removed from a queue of navigation directions, and replaced with one more or more navigation directions to facilitate navigation toward the replacement charging station corresponding to listing 664-1. Representation 660, for example, is optionally reduced in scale to indicate a reduced relevance to navigation along the determined route (e.g., suggested route 610-2 shown in FIG. 6H). Additionally, route indication 648 is updated to guide the user of the electronic device 500 toward the replacement charging stop. Instructions 642 for example, are updated in FIG. 6N to reflect updated navigation direction(s) toward the replacement destination, and that navigation directions toward the previous next-destination (e.g., the previous charging stop) have been replaced with an updated next-destination. Additionally, indication 654 is updated to reflect an updated estimate of amount of charge that the vehicle will have upon arrival at the next stop, and indication 652 is updated to reflect an estimated time of arrival at the replacement charging station.

FIG. 6O illustrates an embodiment in which the user has traveled along suggested route 610-2 (shown in FIG. 6H) and is approaching the suggested charging stop along suggested route 610-2. In some embodiments, device 500 determines that the user has traveled along suggested route 610-2 and is approaching the suggested charging stop (e.g., suggested stop 632-1 from FIG. 6H, represented by representation 660) using one or more device location mechanisms or processes (e.g., using a GPS locator on device 500). In some embodiments, when a location corresponding to the user approaches a next destination, and/or in accordance with a determination that one or more criteria are satisfied, the electronic device 500 initiates a process to search for replacement destination(s) without displaying a list of prospective replacement destinations. For example, in response to detecting the location of the electronic device 500 is within a threshold distance (e.g., 0.1, 1, 10, 100, 1000, or 10,000 m) of the charging stop corresponding to representation 660, the electronic device 500 updates user interface 650 to include a prompt 670 to replace the current charging stop. In some embodiments, in accordance with a determination the one or more criteria are satisfied, not including a criterion satisfied when the location corresponding to the user approaches the next destination, the electronic device 500 initiates the process to search for the replacement destination(s). For example, in accordance with a determination that a level of activity of the next destination is greater than a threshold level of activity, optionally independent of a distance between a location corresponding to electronic device 500 and the next destination, electronic device 500 displays one or more of the buttons 672-1 and/or 672-2 in FIG. 6O described below, and/or buttons 631-1 and/or buttons 631-2 in FIG. 6L above.

Prompt 670 includes information describing a potential replacement charging stop, such as a charging network associated with the replacement charging stop, an address of the replacement charging stop, a button 672-1 that is selectable to forgo the replacing, and a button 672-2 that is selectable to proceed with the replacing of the current charging stop with the replacement charging stop. In some embodiments, button 672-2 indicates an amount of travel time replacing the current charging stop will add or subtract, and/or an amount of travel time it is estimated to take to reach the replacement charging stop. In some embodiments, the proposed replacement charging stop is determined based on a sharing of characteristics (e.g., supported charging standards (e.g., connector types) and/or speeds) between a current and a replacement charging stop, based on if the replacement charging stop is within a preferred network (e.g., preferred via the user account, from user-specified settings, and/or from vehicle-specified settings) based on if the vehicle is estimated to reach the replacement charging stop with a level of charge greater than a threshold level of charge (e.g., 5, 10, 25, 50, 75, 80, or 90% charge), based on if the replacement charging stop is within a threshold distance (e.g., 0.1, 1, 10, 100, 1000, or 10,000 m) of the electronic device 500, and/or based on if the activity level of the replacement charging stop is not greater than the threshold level of activity described previously. For example, indication 662 is updated to describe a number of available chargers at the upcoming charging stop (e.g., “1/10 chargers available”), which is greater than a threshold level of activity (e.g., 5, 10, 25, 50, 75, or 90% of chargers are unavailable). User input 603 is detected in FIG. 6O, including a selection of button 672-2 to replace the current charging stop and update the navigation directions. In some embodiments, if prompt 607 is displayed for an amount of time greater than a threshold amount of time (e.g., 0.1, 10, 100, 1000, or 10000 seconds) without detecting user input dismissing the replacing of the next charging stop (e.g., selection of button 672-1), electronic device 500 automatically replaces the current charging stop with the proposed replacement charging stop. In some embodiments, the amount of time the prompt has been displayed is visually indicated, such as a changing of a fill of the button 672-2 as time elapses. For example, electronic device 500 optionally displays or animates a changing of a saturation and/or color of a gradually increasing portion of button 672-2 (e.g., from left to right and/or right to left of the button), where the portion with the changed saturation and/or color optionally is based on proportion of the threshold time that has elapsed (e.g., 10% of the leftmost portion of the button changes in fill when 10% of the threshold time has elapsed, 50% of the portion of the button changes in fill when 50% of the threshold time has elapsed, and/or 90% of the portion of the button changes in fill when 90% of the threshold time has elapsed). It is understood that the elapsing of time optionally is additionally or alternatively indicated. For example, an additional visual indication such as a timer is displayed to convey the elapsing of time is optionally displayed, an another animation and/or change in visual appearance of button 672-2 is optionally displayed, and/or non-visual feedback such as haptic feedback and/or audible feedback is provided by the electronic device and/or another device in communication with the electronic device.

From FIG. 6O to FIG. 6P, electronic device 500 updates the navigation directions and user interface 640 to guide the user toward a replacement charging stop in response to user input 630 in FIG. 6O, and the user proceeds to navigate along the updated determined route. For example, indication 662 is updated to indicate the availability of chargers at the updated, next charging stop (e.g., “10/10 chargers available”), and prompt 607 is no longer displayed in user interface 650. Additionally, the scale of representation 660 is decreased, to emphasize the reduced relevance of the corresponding charging stop, and instructions 642 are updated to guide the user toward the replacement charging station.

It is understood that as described further with reference to method 700, when electronic device 500 reaches and/or gets within a threshold distance of a next destination, electronic device 500 optionally initiates a process to replace the next destination with another destination if one or more criteria are satisfied. Additionally or alternatively, in some embodiments, in accordance with a determination one or more criteria are satisfied as described previously and described further below, not including a criterion satisfied when the location corresponding to the electronic device 500 reaches and/or gets within the threshold distance of the next destination, electronic device 500 initiates the process to replace the next destination with the other destination. The one or more criteria optionally include a criterion satisfied when a level of activity of the next destination is greater than a threshold level of activity, described above, and additionally or alternatively include one or more criteria that are respectively satisfied when the vehicle associated with the electronic device can reach the replacement destination with a threshold level of charge, when activity levels of the replacement destination are less than the threshold level of activity, when the replacement destination is less than a threshold distance away from a current location of the electronic device, when a time to reach and/or recharge at the next destination exceeds a threshold amount of time, and/or when an added time to reach the replacement destination instead of the next destination is less than a threshold amount of time. In some embodiments, when the vehicle has a cruising range based on the level of charge of batteries of the vehicle that is large enough for the vehicle to reach a next destination including a charging station—such as the end of a determined route and/or to another destination including charging capability along the determined route and already included in navigation directions along the determines route—the electronic device forgoes navigation toward the next destination, and presents one or more navigation directions toward another destination along the determined route.

FIG. 7 is a flow diagram illustrating a method 700 of presenting navigation routes in accordance with user preferences, in accordance with some embodiments, such as in FIGS. 6A-6P. The method 700 is optionally performed at an electronic device such as device 100, device 300, device 500 as described above with reference to FIGS. 1A-1B, 2-3, 4A-4B and 5A-5H. Some operations in method 700 are, optionally combined and/or the order of some operations is, optionally, changed.

In some embodiments, method 700 is performed at an electronic device (e.g., associated with a user account) that is in communication with one or more input devices and a display generation component. For example, the electronic device is optionally a mobile device (e.g., a tablet, a smartphone, and/or a media player), a computer (e.g., a desktop computer and/or a laptop computer), and/or a wearable device (e.g., a watch and/or a head-mounted device). In some embodiments, the display generation component is a display integrated with the electronic device (optionally a touch screen display) and/or an external display such as a monitor, projector, and/or television or a hardware component (optionally integrated or external) for projecting a user interface or causing a user interface to be visible to one or more users. In some embodiments, method 700 is performed at and/or by a vehicle (e.g., at an infotainment system of an automobile having or in communication with one or more display generation components and/or one or more input devices). In some embodiments, the one or more input devices include one or more sensors, such as one or more imaging, resistive, capacitive, acoustic, electromechanical, and/or electromagnetic sensors included in and/or communicatively coupled to the electronic device.

In some embodiments, the user account is an account that corresponds to credentials (e.g., electronic communication address(es), password(s), identifier(s), phone number(s), and/or name(s) of users) registered with a trusted entity, such as one or more computing devices (e.g., servers) configured to enroll, store, and identify the user account using the credentials. For example, the user account is optionally logged into the electronic device and/or one or more applications stored in memory of the electronic device, and relates user information with the electronic device and/or the one more applications, such as one or more vehicles (e.g., electric powered vehicles) with the electronic device and/or the one more applications. As an example, the electronic device stores a maps application in memory, configured to present one or more maps and/or provide navigation directions along routes to one or more destinations. In some embodiments, the electronic device additionally or alternatively determines, modifies, and/or proposes one or more routes based on additional or alternative information different from the information provided by the user account, such as from user-specified settings and/or from vehicle-specified settings of a current vehicle communicatively coupled to the electronic device.

In some embodiments, while the electronic device is providing navigation directions for a determined route using a maps application, the electronic device detects (702a), via the one or more input devices, an event, such as an event including movement of a location corresponding to electronic device 500 in FIG. 6J. For example, the electronic device optionally displays a user interface of the maps application including a current location of and/or corresponding to the electronic device displayed on a map and including one or more directions along a route determined from a first location (e.g., an initial location of the electronic device when the navigation is initiated and/or a current location of the electronic device and/or an initial location provided by user input) to a first destination (e.g., a location along the route and/or a final destination of the route provided by user input), thus providing the navigation directions along the determined route. As an additional example, the one or more directions include one or more distances of upcoming direction(s), such as one or more turns on to streets, one or more freeway onramps, one or more freeway exits, one or more lanes to merge to, and/or one or more indications to remain traveling along a current roadway. In some embodiments, providing navigation directions includes communicating one or more indications to a vehicle to cause the vehicle to follow the navigation directions, such as directly to the vehicle and/or via one or more intermediate electronic devices in communication with the electronic device and the vehicle. In some embodiments, providing navigation directions includes displaying audio describing the navigation directions. In some embodiments, providing navigation directions includes a combination of the one or more previously described embodiments, forgoing providing of one or more other of the described embodiments (e.g., displaying navigation directions without providing audio describing the navigation directions, communicating navigation directions to another device (e.g., a vehicular device) without displaying an indication of the navigation directions), and/or concurrently providing one or more navigation directions using one or more of the described embodiments.

In some embodiments, the determined route is previously determined (e.g., in response to initiating navigation including the navigation directions and/or in response to determining an updated route) before the event is detected. In some embodiments, the determined route is determined in real-time, or nearly real time.

In some embodiments, in response to detecting the event (e.g., immediately, nearly immediately, and/or at a time after the event is detected) (702b), in accordance with a determination that the event satisfies one or more first criteria, including a criterion that is satisfied when a level of activity associated with a first destination that is included in the determined route is greater than a threshold level of activity, wherein the first destination is associated with a preferred charging network (e.g., associated with the user account), the electronic device initiates (702c) a process to modify the determined route to replace the first destination with a second destination, different from the first destination, in the determined route, such as a process including displaying a prompt including selectable option 631-2 in user interface 650 in FIG. 6L. For example, the when the first destination is relatively too busy to accommodate the electronic device and/or a vehicle associated with the electronic device, the electronic device optionally initiates a process to modify the determined route toward a destination that is relatively less busy and is able to accommodate the electronic device and/or the vehicle associated with the electronic device. In some embodiments, the first destination is and/or includes a fueling station (e.g., an electric vehicle charging station and/or a fossil fuel refilling station). In some embodiments, the fueling station is associated with one or more fueling networks (e.g., charging networks). For example, the fueling station optionally includes one or more electric vehicle chargers that are owned and/or associated with a network of charging stations, such as a company owning and/or leasing one or more charging stations. It is understood that description of charging networks apply where appropriate to fueling networks and/or vice-versa. In some embodiments, a respective charging network is associated with (e.g., includes) types of chargers, such as chargers having one or more common characteristics, such as one or more supported charging standards supported by the chargers (e.g., including a type of connector for coupling a charger to the vehicle and/or voltage and/or power level(s) supported by the charger). For example, the respective charging network includes one or more types of chargers, including first respective chargers of a first type of charger that share one or more respective first characteristics (e.g., first charging standards) and/or including second respective chargers of a second, different type of charger that share one or more respective second characteristics (e.g., second charging standards). In some embodiments, respective vehicles are configured to support one or more types of chargers (e.g., one or more charging standards), and thus are compatible with a respective network that includes compatible chargers. In some embodiments, the user account is associated (e.g., is registered with, subscribed to, temporarily purchased a discount plan with, and/or indicated a preference for) one or more networks of charging stations, at times referred to herein as one or more “preferred charging networks.” As an additional example, the first destination optionally includes first one or more chargers that are owned by and/or otherwise associated with the preferred charging network the user account subscribes to. In some embodiments, the level of activity being greater than the threshold level of activity corresponds to when a number of chargers greater than a threshold number of chargers are unavailable (e.g., 1, 2, 3, 5, 10, 20, 30, 50, 100, 200, or 1000 chargers are in use, reserved, and/or are not functioning properly) and/or a proportion of unavailable chargers relative to a total number of chargers is greater than a threshold proportion (e.g., 10, 20, 30, 50, 70, 90, or 95% of the total numbers of chargers are unavailable). In some embodiments, any determination about availability of the chargers is determined relative to chargers included in the preferred charging network of the user account. In some embodiments, the availability of the chargers is determined relative to chargers that are included in, and/or other chargers that are not included in, the preferred charging network. In some embodiments, in accordance with a determination that the number and/or proportion of available chargers associated with the preferred charging network is less than a threshold number and/or proportion, the first electronic device determines availability based on the number and/or proportion of chargers including in-network and out-of-network chargers (e.g., relative to the preferred charging network). In some embodiments, the one or more criteria include a criterion that is satisfied when an amount of traffic at and/or around the first destination is greater than a threshold level of traffic, a predicted level of activity in light of historical activity data at the first destination exceeds a respective level of activity (e.g., the threshold level of activity), a size of a queue formed at and/or around the first destination exceeds a threshold size, and/or a predicted level of availability based on a current fueling status of respective vehicles at the first destination exceeds a respective level of activity (e.g., the threshold level of activity). In some embodiments, the one or more criteria include a criterion that is satisfied when a predicted fuel level (e.g., level of charge) of the vehicle associated with the electronic device will be less than or greater than a threshold level when reaching the first destination (e.g., 1, 3, 5, 10, 15, 25, 40, 50, 60, 75, 85, or 90%). In some embodiments, the one or more criteria do not include the criterion satisfied when the level of activity associated with the first destination is greater than the threshold level of activity, and/or the one or more criteria include respective criterion or criteria described further below. Thus, in some embodiments, in accordance with a determination that an alternative destination is better suited to accommodate fueling and/or charging needs of the vehicle associated with the electronic device, the electronic device initiates one or more operations to provide navigation toward a second destination in place of the first destination.

In some embodiments, the second destination has one or more characteristics of the first destination. For example, when the first destination includes a first charging station (e.g., included in the preferred charging network associated with the user account, specified via user-specified settings, and/or specified via vehicle-specified settings), the second destination includes a second, different charging station (e.g., also included in the preferred charging network). In some embodiments, the first destination is not associated with (e.g., does not include chargers associated with) the preferred charging network and the second destination is associated with the preferred charging network, and/or vice-versa. In some embodiments, the second destination is determined as a candidate to replace the first destination when the second destination does not satisfy the one or more first criteria.

In some embodiments, the process to replace the first destination with the second destination includes ceasing display of one or more of navigation directions guiding the electronic device toward the first destination, forgoing performing operation(s) presenting such navigation directions toward the first destination, initiating display of navigation directions and/or otherwise providing navigation directions toward the second destination, concurrently displaying one or more visual indications and/or selectable options to notify a user of the electronic device that the second destination is available as an alternative destination, causing playback of audio to notify the user that the second destination is available, displaying a timer indicating that the first destination will be replaced with the second destination if the electronic device does not detect that the user wishes to continue navigation toward the first destination, determining a respective destination that does not satisfy the one or more criteria that will be the second destination, and/or determining whether or not the respective destination will satisfy the one or more criteria at a time when the electronic device will arrive at the second destination.

In some embodiments, in response to detecting the event (e.g., immediately, nearly immediately, and/or at a time after the event is detected) (702b), in accordance with a determination that the event does not satisfy the one or more first criteria, the electronic device forgoes (702d) the initiating of the process to modify the determined route to replace the first destination with the second destination in the determined route, such as not displaying selectable option 631-2 in FIG. 6L. For example, the electronic device optionally forgoes determining of a candidate destination to replace the first destination, forgoes performing one or more operations to present the second destination, and/or forgoes modification of the navigation directions presented via the display generation component. Initiating a process to replace a first destination with a second destination along a route in accordance with a determination that an event satisfies one or more first criteria reduces user input required to evaluate alternative destinations and/or update navigation directions to manually replace the first destination with the second destination, thereby improving user safety when traveling in a vehicle and saving processing required to manually detect and process the manual user input.

In some embodiments, the first destination includes a first charging station associated a first user preference (e.g., with the user account), such as first stop 630-1 in FIG. 6H, and the second destination includes a second charging station associated with a second user preference (e.g., the user account), such as a charging stop corresponding to listing 664-1 in FIG. 6M. For example, the first destination optionally is or includes a first electric vehicle charging station associated with a first charging network, and the second destination optionally is or includes a second, different electric vehicle charging associated with the first charging network. In some embodiments, the second charging station has one or more characteristics that are the same as the first charging station. For example, the first and the second charging station optionally include one or more electric vehicle chargers that are associated with a preferred charging network associated with the user account (e.g., owned and/or leased by the preferred charging network). In some embodiments, the second charging station is associated with a different charging network than the first charging station. For example, the second charging station is associated with a second charging network that is also preferred (e.g., relatively less preferred, more preferred, or at an equivalent preference level) based on settings of the user account, and/or the charging station is not associated with a preferred charging network, and is optionally associated with another charging network that is not preferred (e.g., the user account does not include settings indicating preference for the other charging network). In some embodiments, the first destination and/or the second destination includes one or more chargers associated with the preferred network(s) of the user account and/or one or more chargers not associated with preferred network(s) of the user account. In some embodiments, the level of activity of the first destination described above is based on the number and/or proportion of charging stations available for use with a vehicle associated with the electronic device and/or the user account. Replacing the first destination including the first charging station with a second destination including a second charging station when a level of activity of the first station is greater than the threshold level of activity reduces the likelihood of navigating toward a respective destination lacking charging capabilities required by a device associated with the electronic device, such as one or more batteries of a vehicle, reducing manual inputs to explicitly query for and/or manual inputs required to confirm that respective destinations include a charging station, thereby reducing processing required to handle such manual inputs.

In some embodiments, before detecting the event, the second destination is included, and after the first destination, along the determined route, such as a destination included in a queue of navigation directions after first stop 630-1 in FIG. 6H. For example, the second destination is a next destination in a queue of the navigation directions immediately following the first destination, and/or is a destination that is later in the queue than the first destination, such as when one or more navigation directions are sequentially in between the first destination and/or the second destination. In some embodiments, the second destination was previously included in the navigation directions (e.g., when the determined route was initially determined), without requiring one or more inputs to add the second destination to the navigation directions. In some embodiments, the second destination is added to the queue of navigation directions after navigation along the determined route is initiated and before a location corresponding to the electronic device corresponds to the first destination. For example, in response to detecting a voice command, one or more touch inputs directed to a touch screen of the electronic device, one or more air gestures, and/or automatically in response to satisfaction of respective criteria, the second destination is added to the navigation directions before the location corresponding to the electronic device reaches the first destination.

In some embodiments, the one or more first criteria include a criterion that is satisfied when the maps application indicates a level of charge of one or more batteries of an electronic vehicle associated with the electronic device, such as one or more batteries included in an electric vehicle corresponding to listing 636-1 in FIG. 6C, will be greater than a threshold level of charge when a location corresponding to the electronic device is estimated to reach the second destination, such as a level of charge indicated by indication 654 in FIG. 6J. For example, the electronic device and/or the maps application detects and/or provides (e.g., displays and/or communicates) an indication of charge of a single battery, a plurality of batteries, and/or one or more fuel sources including the single and/or the plurality of batteries, such as gasoline levels. In some embodiments, the second destination is associated with the preferred charging network. It is understood that description herein referring to a level of charge of one or more batteries are optionally applicable to levels of charge of multiple batteries, to levels of fuel of additional or alternative fuel sources, to combined metrics corresponding to a levels of charge of a plurality of batteries (e.g., an average level of charge, median level of charge, a total level of charge relative to a total capacity, and/or other suitable metrics), and/or some combination of the previously described descriptors of levels of charge and/or fuel. In some embodiments, the electronic device and/or the maps application determines an estimated level of charge that the one or more batteries associated with the electronic device when the location corresponding to the electronic device reaches one or more portions along the determined route and/or alterations to the determined route. For example, the electronic device optionally determines estimates of levels of charge of one or more batteries included in a vehicle registered to the user account, when a location of the electronic device and/or the vehicle are estimated to reach the first destination and/or the second destination. In some embodiments, the one or more first criteria include a criterion that is satisfied when one or more informational sources indicate the level of charge of the one or more batteries associated with the electronic device will be greater than the threshold level of charge when the location corresponding to the electronic device is estimated to reach the second destination. For example, the informational source(s) optionally include a software application included in memory of the electronic device and/or of another device in communication with the electronic device (e.g., an electronic battery monitoring subsystem included in a vehicle communicatively coupled to the electronic device (e.g., wirelessly and/or via wired connection), one or more computer systems such as servers in communication with the electronic device, and/or one or more intermediate electronic device such as an infotainment system in communication with the battery monitoring subsystem). It is understood that embodiments described herein related to the maps application providing information (e.g., charge of one or more batteries, estimates of time to traverse one or more portions of the route, levels of activity of destinations, and/or distances to destinations) similarly applies to embodiments where the informational source(s) described previously provide the information instead of and/or in conjunction with the maps application. For example, the one or more first criteria and/or the one or more second criteria herein include respective criterion satisfied when the informational source(s) provide an indication of the information described previously. In accordance with a determination that an estimated level of charge of the one or more batteries is greater than a threshold level of charge (e.g., 1, 3, 5, 10, 15, 30, 40, 50, 60, 70, 80, and/or 90%) based on information from the informational source(s), the electronic device optionally initiates the process to replace the first destination with the second destination. For example, if the estimated level of charge of the one or more batteries is expected to be greater than the threshold level of charge when the location of the electronic device and/or vehicle reaches the second destination, the electronic device determines that stopping at the first destination to charge the one or more batteries is optional, and thus initiates the process to replace the first destination with the second destination. In some embodiments, when the one or more first criteria are satisfied, the electronic device displays a selectable option that is selectable to initiate a skipping of the first destination, and/or skips and/or replaces the first destination without detecting user input and/or without displaying the selectable option, instead displaying a visual indication that the first destination has been replaced and/or skipped. As described above, the one or more first criteria optionally include the criterion that is satisfied based on the level of activity and additionally or alternatively include the criterion satisfied based on the estimated level(s) of charge of the one or more batteries.

In some embodiments, the second destination is not associated with the preferred charging network associated with the preferred charging network, such as the second charging stop 630-2 shown in FIG. 6H. For example, the second destination optionally does not include a respective charging station, includes one or more charging stations outside of the preferred charging network, and/or does not include one or more charging stations associated with the preferred charging network. Replacing the first destination with the second destination when an estimated level of charge of one or more batteries is greater than a threshold level of charge when a location of the electronic device is estimated to correspond to the second destination reduces user input required to manually determine the estimates of levels of charge, thereby improving efficiency when interacting with the electronic device and/or when considering feasibility of replace the first destination and reduces processing required to handle the user input.

In some embodiments, the one or more first criteria include a criterion that is satisfied when the maps application indicates a location corresponding to the electronic device is within a threshold distance (e.g., 0.01, 0.1, 1, 10, 100, 1000, or 10,000 m) of the first destination, such as a location of electronic device 500 and/or a vehicle corresponding to electronic device 500 moving within a threshold distance of a stop corresponding to indication 660 in FIG. 6J. For example, the electronic device and/or the maps application optionally directly detects and/or detects an indication of a location of a vehicle associated with the user account, of the electronic device, and/or of another device traveling with the electronic device that is in communication with the vehicle. When the location and/or the indication of location is determined to be within the threshold distance of the first destination, the electronic device optionally initiates the process to replace the first destination with the second destination. In some embodiments, the threshold distance is determined based on user settings of the user account, explicitly defining the threshold distance. In some embodiments, the threshold distance is fixed (e.g., by the maps application). In some embodiments, the threshold distance is dynamically determined based on a predicted and/or current velocity of the electronic device and/or the vehicle, relatively increasing when the velocity is relatively high, and relatively decreasing when the velocity is relatively low. Initiating the process to replace the first destination with the second destination when the location corresponding to the electronic device is within the threshold distance reduces manual user input required to request the initiation of the process, thereby improving interaction efficiency with the electronic device, safety of the user while concurrently operating a vehicle, and reducing processing required to process the manual user input.

In some embodiments, the process to modify the route includes displaying, via the display generation component, a selectable option that is selectable to initiate a process to search for the second destination, such as button 631-2 as shown in FIG. 6L and/or such as button 672-2 as shown in FIG. 6O. For example, in accordance with the determination that the one or more first criteria are satisfied and in response to detecting the event, the electronic device displays information indicating that the route is able to be modified, the information including the selectable option. The information is optionally displayed concurrently with additional user interface(s) and/or visual indications, such as concurrently with a representation of a map provided by the maps application and/or including the location corresponding to the electronic device described with reference to above overlaid on the representation of the map, and/or one or more selectable options that are selectable to display one or more navigation directions, to display information associated with a vehicle associated with the electronic device, and/or to temporarily or permanently cease the navigation directions along the determined route. In some embodiments, in response to detecting input directed to the selectable option (e.g., a pressing of a touch screen, a voice command, an air gesture, and/or a selection of a button in communication with the electronic device such as a button included on a steering wheel of the vehicle), the electronic device initiates the process to search for the second destination. In some embodiments, the selectable option is automatically selected, without detecting an express user input directed to the selectable option, such as if the selectable option has been displayed for a period of time greater than a threshold period of time (e.g., 0.5, 1, 2.5, 5, 7.5, 10, 20, 30, or 60 seconds). In some embodiments, the electronic device plays or causes another device to play audio corresponding to the selectable option, prompting the user to provide or not provide input to initiate the replacing of the first destination with the second destination.

In some embodiments, the process to search for the second destination includes performing a search in response to detecting the selection of the selectable option, such as a selection input included in user input 603-2 in FIG. 6L, includes performing a search without detecting an express user input to identify and/or initiate the search, such as after an elapsing of time without detecting user input 603 in FIG. 6O, and/or provide search criteria for the search (e.g., user input initiates the search, but the content of the search (e.g., the search criteria) is determined by the electronic device without user input specifying the search content), such as an input causing display of listings 634 in FIG. 6M, and/or includes displaying one or more search results, such as listings 634 in FIG. 6M. For example, in response to detecting a selection input (e.g., input directed toward the selectable option described previously), the electronic device displays, causes display, and/or provides non-visual feedback (e.g., announcement of) prospective destinations to replace the first destination. In some embodiments, one or more search results are included and/or displayed in a region of a user interface of the maps application, due to their association with the preferred charging network of the user account. For example, the search results optionally include one or more charging stations that includes one or more chargers associated with a preferred network of the user account listed, optionally consuming a first region of the user interface of the maps application. Additionally or alternatively, the search results optionally include one or more charging stations not associated (e.g., not included in) the preferred network, but satisfying one or more replacement criteria (e.g., a criterion satisfied when the replacement station is relatively close to the location corresponding to the electronic device (e.g., within 0.1, 1, 10, 100, 1000, 10000, or 100000 km), a criterion satisfied when activity levels of the replacement station is less than the threshold level of activity, similar to as described above, and/or a criterion satisfied when the replacement station includes charger(s) having characteristic(s) similar to those of the first destination such as a speed of the charger(s) and/or a connector of the charger(s)). In some embodiments, the search results include one or more indications of association between respective search results and the preferred network, such as indication that a respective search result is in the preferred network or is outside of the preferred network including descriptive information and/or graphical icons corresponding to a corresponding network of the respective search result. In some embodiments, the search results are displayed overlaid over the representation of the map provided by the maps application. In some embodiments, the search results are individually selectable to display additional information associated with the selected search results, and/or to replace the first destination with the selected search result, the selection of the respective search results included in the process to replace the first destination with the selected search result as the second destination. In some embodiments, the search results include indications of distance relative to the location corresponding to the electronic device, indications of availability (e.g., a number of available chargers) of the search result, indications of the respective fueling network associated with search result, and/or an indications of an estimated travel time to reach the search result (e.g., an additional amount of time relative to a current location corresponding to the electronic device). In some embodiments, the electronic device displays one or more filters with the search results, such as a filter to display results including particular characteristics of chargers, a filter to display destinations associated with a particular charging network, a filter to set a threshold distance of possible search results, a filter to set a threshold level of activity of the search results, and/or a filter to set a predicted cost of charging one or more batteries associated with the electronic device to less than a threshold amount. In some embodiments, in response to detecting a selection of a search result, the electronic device determines the selected search result is the second destination, and replaces the first destination with the second destination as part of the process to replace the first destination with the second destination, as described previously. Displaying a selectable option that is selectable to search for the second destination reduces user input to manually browse for suitable replacement destinations, thereby improving user safety when operating a vehicle and reducing processing required to process the manual user input.

In some embodiments, the one or more first criteria include a criterion that is satisfied when the maps application indicates that an estimated level of charge of one or more batteries of an electronic vehicle associated with the electronic device will be greater than a threshold level of charge (e.g., 1, 3, 5, 10, 15, 30, 40, 50, 60, 70, 80, or 90%) when the electronic device reaches the first destination, such as a level of charge indicated by indicator 654 in FIG. 6J, optionally greater than as illustrated in FIG. 6J. For example, similar to as described above, the electronic device and/or the maps application optionally determines an estimate level of charge of one or more batteries included in a vehicle associated with the electronic device and/or the user account that the one or more batteries will reach when a location corresponding to the electronic device (e.g., of the vehicle and/or the electronic device) is estimated to reach the first destination. When the estimated level of charge is greater than a threshold level of charge and/or when the activity level of the first destination satisfies the criterion described above, the electronic device optionally initiates the process to replace the first destination with the second destination, for example, when visiting the first destination to charge would add excess travel time along the determined route, and/or when visiting the first destination would be less efficient with a user's time than visiting the second destination to charge due to a predicted time to charge at the first destination (e.g., due to availability and/or charging speed). Replacing the first destination with the second destination when the estimated level of charge is predicted to be greater than the threshold level of charge at a time when the location corresponding to the electronic device is estimated to reach the first destination reduces user input required to determine the level of charge and/or user input required to determine if visiting the first destination is required, thereby reducing processing required to detect the user input and improving user safety when operating a vehicle and attempting to make such determinations.

In some embodiments, the one or more first criteria include a criterion that is satisfied when the maps application indicates that an estimated level of charge of one or more batteries of the electronic vehicle (optionally associated with the user account) will be less than a threshold level of charge (e.g., 1, 3, 5, 10, 15, 30, 40, 50, 60, 70, 80, or 90%, optionally the same as or different from the threshold described above) when the electronic device reaches the first destination, such as a level of charge indicated by indicator 654 in FIG. 6J. For example, similar to as described above, the electronic device and/or the maps application optionally determines that one or more batteries included in a vehicle associated with the electronic device and/or the user account are estimated to reach a level of charge when a location corresponding to the electronic device (e.g., of the vehicle and/or the electronic device) is estimated to reach the first destination. When the estimated level of charge is less than a threshold level of charge and/or when the activity level of the first destination satisfies the criterion above, the electronic device optionally initiates the process to replace the first destination with the second destination, for example, when attempting to reach the first destination would incur a risk of draining the one or more batteries to a level that is detrimental to the health of the one or more batteries and/or detrimental safety and/or convenience of the user of the electronic device, and/or when replacing the second destination with the first destination is more efficient with a user's time than visiting the first destination to charge. Replacing the first destination with the second destination when the estimated level of charge is predicted to be less than a threshold level of charge reduces user input required to determine the level of charge and/or whether visiting the first destination is required, thereby reducing processing required to detect the user input and improving user safety when operating a vehicle and attempting to make such determinations.

In some embodiments, the one or more first criteria include a criterion that is satisfied when the maps application indicates that a travel time to traverse a respective portion of the route, wherein the respective portion of the route includes the first destination, is greater than a threshold amount of time (e.g., 0.01, 0.1, 1, 10, 100, 1000 minutes), such as an amount of time estimated to travel to the first stop corresponding to indication 660 in FIG. 6J from a location corresponding to indication 646 in FIG. 6I. For example, when a travel time along a portion of the route exceeds the threshold amount of time, such as an estimated amount of time required to stop at the first destination and/or charge at the first destination, the electronic device initiates the process to replace the first destination with the second destination. One or more criteria based on the travel time are optionally included in the one or more first criteria to optimize the travel time to navigate along a determined route to a final destination and/or to reduce the likelihood that the user of the electronic device is exposed to excess traffic and/or idling, without traveling and/or charging. The estimated travel time to traverse the respective portion of the route optionally includes estimates of amount(s) of time required to reach the first destination from a current location corresponding to the electronic device, estimates of amount(s) of time required to enter the first destination, estimates of amount(s) of time required to wait for available chargers, estimates of amount(s) of time required to charge one or more batteries associated with the electronic device, amount(s) of actual travel time along previous portions of the route (e.g., starting from when the location corresponding to the electronic device reached a previous destination and/or a start of the determined route while navigation is ongoing) and/or estimates of amount(s) of time required to exit the first destination and/or travel toward a key portion of the determined route (e.g., a key highway and/or street). Additionally or alternatively, the one or more first criteria optionally include a criterion satisfied when the maps application indicates that the estimated travel time to traverse a respective second portion of the route including the second destination is less than a threshold amount of time (e.g., the same or different as the threshold amount of time described previously). For example, when replacing the first destination with the second destination results in a net decrease in time spent navigating along the determined route and/or presents a comparable travel time while providing access to a less active destination and/or to a destination that is also included in a preferred network of the user account, the electronic device initiates the process to replace the first destination with the second destination. Thus, the electronic device optionally determines an estimated impact of traveling to and/or visiting the first destination and/or the second destination, and when criteria associated with estimates of the travel times are satisfied, initiates the process to replace the first destination with the second destination. In some embodiments, the one or more first criteria include respective criterion that are respectively satisfied when a location corresponding to the electronic device is less than a threshold time (e.g., 0.01, 0.1, 1, 10, 100, 1000 minutes) from the second charging station, when the charging at the first destination is not currently available and/or is not estimated to be available by a time the location corresponds to the electronic device reaches the first destination, when the second destination will add less than a threshold amount of time to navigating along the determined route (e.g., 0.01, 0.1, 1, 10, 100, 1000 minutes), and/or when one or more chargers of the second destination are of a comparable or better speed than one or more chargers of the first destination. Replacing the first destination with the second destination when an estimated time to traverse a portion of the determined route exceeds a thresholds amount of time reduces user input to discover alternative destinations and/or determine impact on travel time along the determined route, thereby reducing processing required to handle such user input and improving safety of the user attempting to operate a vehicle associated with the electronic device.

In some embodiments modifying the route to replace the first destination with the second destination includes in accordance with a determination that the first destination has one or more first characteristics, selecting a first respective destination as the second destination, wherein the first respective destination has the one or more first characteristics, such as one or more fast chargers indicated by information 662 in FIG. 6P, replacing one or more fast chargers indicated by information 662 in FIG. 6O. For example, as described above, when the maps application determines and/or indicates that the first destination has one or more first characteristics, the electronic device optionally selects a replacement destination that has the same one or more first characteristics (e.g., first supported charging standards, charging speeds, and/or is associated with a first network preferred by the user account). In some embodiments the first respective destination does not have one or more of the one or more second characteristics described below.

In some embodiments, modifying the route to replace the first destination with the second destination includes in accordance with a determination that the first destination has one or more second characteristics different from the one or more first characteristics, selecting a second respective destination, different from the first respective destination, as the second destination, wherein the second respective destination has the one or more second characteristics such as one or more slow chargers indicated by information 662 in FIG. 6P, replacing one or more slow chargers indicated by information 662 in FIG. 6O. For example, as described above, when the maps application indicates that the first destination has one or more second characteristics, (e.g., second supported charging standards, speeds, and/or is associated with a second network) the electronic device optionally selects a replacement destination that has the second one or more characteristics, and/or does not have at least a portion of the one or more first characteristics. In some embodiments the second respective destination does not have one or more of the one or more first characteristics described above. Replacing the first destination with a second destination having respective characteristic(s) of the first destination reduces the likelihood that the second destination lacks characteristic(s) that a user of the electronic device originally desires, thereby reducing user input required to correct replacing of the first destination with a second destination having different characteristics than desired.

In some embodiments, before providing the navigation directions for the determined route, the electronic device detects, via the one or more input devices, one or more inputs corresponding to a request to initiate a process to provide the navigation directions, such as one or more inputs including user input 603 in FIG. 6G. For example, while a representation of a map provided by the maps application is displayed, via the display generation component, the electronic device optionally detects the one or more inputs and/or detects an indication of similar one or more inputs, corresponding to the request to initiate navigation along the determined route described above (e.g., corresponding to the request to initiate the process to provide the navigation directions). Such one or more inputs optionally include an input to initiate the maps application, voice input requesting the navigation directions, one or more inputs searching for, identifying, selecting, and/or browsing the determined routes toward a final destination, and/or one or more inputs optionally initiating a process to cause a vehicle associated with the electronic device to move in accordance with a determined route, such as one or more touch inputs, voice inputs, air gestures (described above) and/or inputs detected via another device in communication with the electronic device (e.g., a mouse, a joystick, an infotainment system, and/or a stylus-type pointing device).

In some embodiments, in response to detecting the one or more inputs, the electronic device displays, via the display generation component, a plurality of proposed routes, including the determined route including the first destination, and a first proposed route, different from the determined route, not including the first destination, such as first proposed route 610-2, second proposed route 610-3, and/or third proposed route 610-1 in FIG. 6H. For example, in response to an input requesting navigation toward the final destination, the electronic device optionally displays, via the display generation component, the plurality of proposed routes from a current location corresponding to the electronic device toward the final destination. In some embodiments, the determined route includes the first destination, and the electronic device visually indicates as such (e.g., by displaying a visual representation such as an icon representative of the first destination and/or a charging network associated with the destination). In some embodiments, a first proposed route is at least partially different from the determined route, and does not include the first destination and/or does not include a respective navigation direction suggesting that a user of the electronic device stop at the first destination; accordingly, the first destination is optionally not visually indicated along the first proposed route. In some embodiments, the first proposed route includes one or more destinations, such as destinations including a charging station, that are visually indicated along the first proposed route. In some embodiments, a relationship between a destination associated with the preferred network associated with the user account and/or associated with one or more user preferences and included in the first proposed route is displayed, such as a description identifying the destination as included in the preferred charging network indicated by the maps application, and/or visually distinguishing a representation of the destination (e.g., with an icon, color, level of bolding, and/or border relative to other destinations not associated with the preferred network). In some embodiments, the electronic device concurrently provides the visual representation of the plurality of proposed routes, and/or additional descriptive information (e.g., in a region of a displayed user interface that is not consumed with a representation of a map or overlaid over the representation of the map, in proximity to the respective proposed routes), such as an estimated time to traverse the respective routes of the plurality of routes, a number of charging stations includes in the respective routes, whether the respective routes include charging station(s) associated with the preferred network of the user account (e.g., partially or entirely), and/or whether the respective routes include any charging stations. In some embodiments, in response to detecting a selection of a respective proposed route (e.g., the determined route and/or the first proposed route), the electronic device initiates display of a preview of the selected route and/or initiates navigation using navigation directions corresponding to the selected route. Displaying a plurality of routes reduces user input required to separately view the routes, thus reducing user input required to serially preview the routes and thereby reducing processing required for such input.

In some embodiments, the first destination includes a first vehicle charging station, such as proposed route 610-2 in FIG. 6H, and the first proposed route does not include a respective vehicle charging station, such as proposed route 610-3 in FIG. 6H. For example, as described above, the determined route includes the first destination, which in turn includes at least a first vehicle charging station, and a respective route included in the plurality of proposed routes optionally does not include a vehicle charging station. In some embodiments, the maps application indicates that the proposed route not including a charging station is not associated with the preferred charging network of the user account. For example, the no-charging route optionally is described as not including destinations to charge, and/or visually indicated (e.g., with a particular icon and/or text, and/or not including icons and/or text associated with charging stations). It is understood that information described with reference to the determined route is optionally presented with respect to additional proposed routes, such as a second proposed route including chargers of non-preferred network(s), and/or including chargers of the preferred network and of the non-preferred network(s). In some embodiments, the electronic device presents some combination of one or more of a first route including a destination associated with the preferred charging network, a second route including a destination not associated with the preferred charging network that is associated with a non-preferred charging network, and/or a third route lacking destinations associated with a charging network. Displaying a plurality of routes including a route without a respective vehicle charging station reduces user input required to separately view the routes, thus reducing user input required to serially preview the routes and thereby reducing processing required for such input, and further reduces user input seeking a route without including a vehicle charging station.

In some embodiments, displaying the plurality of proposed routes includes displaying first information indicating a relationship between the determined route and the preferred charging network associated one or more user preferences (e.g., associated with the user account, and/or and optionally displaying second information indicating a relationship between the first proposed route and the preferred charging network associated with the user account), such as information included in listing 616-1. For example, as described above, the electronic device optionally displays descriptive and/or visual information identifying that the determined route includes one or more (and optionally exclusively includes) destinations including chargers associated with the preferred charging network (e.g., a first charging network) associated with the user account and/or associated with one or more user preferences. For example, the determined route includes one or more icons identifying locations of destinations including in-preferred-network chargers, and/or information identifying the preferred charging network (e.g., the first charging network), such as a name of the network(s) associated with charger(s) along the determined route and/or icons corresponding to a brand of such network(s). It is understood that information described with reference to determined route is optionally presented with respect to additional proposed routes, such as information describing a relationship between the first proposed route and a charging network that is—or is not—the preferred charging network. In some embodiments, the plurality of displayed routes include respective routes based on the preferred charging network, such as the determined route including the first destination associated with the first charging network. Additionally or alternatively, in response to detecting the one or more inputs corresponding to the request to initiate the process to provide the navigation directions described above, and in accordance with a determination that the preferred charging network associated with the user account and/or more user preferences is a second charging network, different from the first charging network, the electronic device optionally displays a second proposed route, optionally different from the first proposed route and/or the determined route described previously, and/or optionally displays a visual indication of the first destination and/or information associated with the second charging network. In some embodiments, in response to the one or more inputs, and in accordance with the determination that the preferred charging network of the user account is the second charging network, the electronic device optionally forgoes display of the determined route and/or the first proposed route. In some embodiments, in response to detecting the one or more inputs corresponding to the request to initiate the process to provide the navigation directions, and in accordance with a determination that the preferred charging network corresponds to a plurality of preferred charging network such as the first charging network and the second charging network, the electronic device displays a proposed route including a first destination associated with the first charging network and/or the second charging network (e.g., including a charger associated with the first and/or the second charging network), and/or displays the proposed route including a second destination, different from the first destination, associated with the first charging network and/or the second charging network. In some embodiments, the proposed route associated with the first charging network and the second charging network displays one or more visual indications (e.g., identifying destinations that are associated with respective charging networks) and/or information associated with the destination(s) included in the proposed route. Displaying information indicating a relationship between the determined route and the preferred charging network associated with the user account reduces the likelihood of detecting erroneous selection of a proposed route not associated with the preferred charging network, thereby reducing processing required to handle such erroneous selections.

In some embodiments, while displaying a user interface of the maps application (for example, the electronic device optionally displays a user interface including a representation of a map of the maps application and/or including one or more selectable options and/or fields that are configured to be populated with information in response to detecting a selection input directed toward the one or more options and/or fields) in accordance with a determination that the user account associated with the electronic device does not satisfy one or more second criteria, different from the one or more first criteria, including a criterion that is satisfied when the user account is associated with a preferred charging network in the maps application, such as a charging network 697-1, 697-2, and/or 697-3 displayed in FIG. 6E, the electronic device displays, via the display generation component, a selectable option that is selectable to initiate a process to associate the user account with the preferred charging network in the maps application, such as a selectable option included in information 605 in FIG. 6A (e.g., “set up preferred charging network”). For example, if the user account is not registered with and/or has not been linked to a preferred charging network (e.g., via the maps application, and/or via another application that has been and/or is in communication with the maps application, included in or external to memory in the electronic device), the electronic device initiates a process to establish an association between the user account and a prospective preferred charging network. In some embodiments, the process includes displaying, in the user interface of the maps application via the display generation component, the selectable option. In some embodiments, the selectable option is accompanied by information describing the lack of registration. In some embodiments, in response to detecting selection of the selectable option, the electronic device displays a user interface (e.g., concurrently, or separately from the maps user interface) corresponding to a setup process, such as shown with reference to FIGS. 6A-6C. In response to detecting one or more inputs identifying a preferred charging network, optionally associated with a vehicle registered with the user account, the electronic device optionally forgoes display of the selectable option and/or the information accompanying the selectable option when displaying the user interface of the maps application, described further below.

In some embodiments, while displaying the user interface of the maps application, in accordance with a determination that the user account associated with the electronic device satisfies the one or more second criteria, forgoing display of the selectable option that is selectable to initiate the process to associate the user account with the preferred charging network in the maps application, such as a selectable option not display in FIG. 6G requesting the user to set up a preferred charging network. For example, in response to detecting an event including a request to display the user interface of the maps application, in accordance with a determination that the user account is registered and/or otherwise indicated a preference for a particular charging network, the electronic device forgoes display of the selectable option and/or information accompanying the selectable option and indicative of a lack of registration. Displaying or not displaying a selectable option to initiate a process to associate the user account with a preferred charging network reduces the likelihood that a proposed route is selected as a determined route for navigation that is more costly and/or indirect, and therefore not preferred, thereby reducing the likelihood to initiate, cancel, and replace navigation along a not preferred route.

In some embodiments, the selectable option that is selectable to initiate the process to associate the user account with the preferred charging network is displayed concurrently with a user interface of the maps application that includes a representation of a map, such as a selectable option included in information 605 displayed concurrently with a representation of map in user interface 600 as shown in FIG. 6A. For example, as described above, the selectable option is displayed overlaid over the representation of the map and/or at a portion of the user interface of the maps application including information associated with the representation of the map, such as selectable option(s) that are selectable to search for potential destinations, to select a commonly used and/or significant destination of the user account as a destination, to select a recently navigated destination as the destination, and/or initiate a process to display a user interface associated with a vehicle, such as a current vehicle and/or a vehicle associated with one or more user preferences. In some embodiments, the selectable option is displayed while navigation along the determined route is not ongoing (e.g., before navigation directions are provided and/or while navigation directions are ceased temporarily or permanently). Displaying a selectable option that is selectable to initiate the process to associated with user account with the preferred charging network concurrently with the map provides flexibility of user input to navigate the representation of the map and/or to establish the association between the user account and referred charging network, reducing user input required to separately cause display of the representation of the maps and the selectable option, and thereby reducing processing required to separately cause and/or cease display of such visual elements.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, detecting operations 702a and initiating and/or forgoing operations 702c and 702d are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to track and locate items that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to identify the location of an electronic device in communication with a vehicle and/or identify the location of the user. Accordingly, use of such personal information data enables users to identify, find, and otherwise interact with such electronic devices. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide location data for targeted content delivery services. In yet another example, users can select to limit the length of location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device that is in communication with one or more input devices and a display generation component:
while the electronic device is providing navigation directions for a determined route using a maps application, detecting, via the one or more input devices, an event; and
in response to detecting the event:
in accordance with a determination that the event satisfies one or more first criteria, including a criterion that is satisfied when a level of activity associated with a first destination that is included in the determined route is greater than a threshold level of activity, wherein the first destination is associated with a preferred charging network, initiating a process to modify the determined route to replace the first destination with a second destination, different from the first destination, in the determined route; and
in accordance with a determination that the event does not satisfy the one or more first criteria, forgoing the initiating of the process to modify the determined route to replace the first destination with the second destination in the determined route.

2. The method of claim 1, wherein the first destination includes a first charging station associated with a first user preference, and the second destination includes a second charging station associated with a second user preference.

3. The method of claim 1, wherein:
before detecting the event, the second destination is included, and after the first destination, along the determined route, the one or more first criteria include a criterion that is satisfied when the maps application indicates a level of charge of one or more batteries of an electronic vehicle associated with the electronic device will be greater than a threshold level of charge when a location corresponding to the electronic device is estimated to reach the second destination, and the second destination is not associated with the preferred charging network.

4. The method of claim 1, wherein the one or more first criteria include a criterion that is satisfied when the maps application indicates a location corresponding to the electronic device is within a threshold distance of the first destination.

5. The method of claim 1, wherein the process to modify the determined route includes displaying, via the display generation component, a selectable option that is selectable to initiate a process to search for the second destination.

6. The method of claim 1, wherein the one or more first criteria include a criterion that is satisfied when the maps application indicates that an estimated level of charge of one or more batteries of an electronic vehicle associated with the electronic device will be greater than a threshold level of charge when the electronic device reaches the first destination.

7. The method of claim 1, wherein the one or more first criteria include a criterion that is satisfied when the maps application indicates that an estimated level of charge of one or more batteries associated with an electronic vehicle will be less than a threshold level of charge when the electronic device reaches the first destination.

8. The method of claim 1, wherein the one or more first criteria include a criterion that is satisfied when the maps application indicates that a travel time to traverse a respective portion of the determined route, wherein the respective portion of the determined route includes the first destination, is greater than a threshold amount of time.

9. The method of claim 1, wherein modifying the determined route to replace the first destination with the second destination includes:
in accordance with a determination that the first destination has one or more first characteristics, selecting a first respective destination as the second destination, wherein the first respective destination has the one or more first characteristics; and
in accordance with a determination that the first destination has one or more second characteristics different from the one or more first characteristics, selecting a second respective destination, different from the first respective destination, as the second destination, wherein the second respective destination has the one or more second characteristics.

10. The method of claim 1, further comprising:
before providing the navigation directions for the determined route, detecting, via the one or more input devices, one or more inputs corresponding to a request to initiate a process to provide the navigation directions; and
in response to detecting the one or more inputs, displaying, via the display generation component, a plurality of proposed routes, including the determined route including the first destination, and a first proposed route, different from the determined route, not including the first destination.

11. The method of claim 10, wherein the first destination includes a first vehicle charging station, and the first proposed route does not include a respective vehicle charging station.

12. The method of claim 10, wherein displaying the plurality of proposed routes includes displaying first information indicating a relationship between the determined route and the preferred charging network associated with a user account associated with the electronic device.

13. The method of claim 1, further comprising:
while displaying a user interface of the maps application:
in accordance with a determination that a user account associated with the electronic device does not satisfy one or more second criteria, different from the one or more first criteria, including a criterion that is satisfied when the user account is associated with a preferred charging network in the maps application, displaying, via the display generation component, a selectable option that is selectable to initiate a process to associate the user account with the preferred charging network in the maps application; and
in accordance with a determination that the user account associated with the electronic device satisfies the one or more second criteria, forgoing display of the selectable option that is selectable to initiate the process to associate the user account with the preferred charging network in the maps application.

14. The method of claim 13, wherein the selectable option that is selectable to initiate the process to associate the user account with the preferred charging network is displayed concurrently with a user interface of the maps application that includes a representation of a map.

15. An electronic device comprising:
one or more processors;
memory; and
one or more programs, wherein the one or more programs are stored in the memory and configured to be executed by the one or more processors, the one or more programs including instructions for:
while the electronic device is providing navigation directions for a determined route using a maps application, detecting, via one or more input devices in communication with the electronic device, an event; and
in response to detecting the event:
in accordance with a determination that the event satisfies one or more first criteria, including a criterion that is satisfied when a level of activity associated with a first destination that is included in the determined route is greater than a threshold level of activity, wherein the first destination is associated with a preferred charging network, initiating a process to modify the determined route to replace the first destination with a second destination, different from the first destination, in the determined route; and
in accordance with a determination that the event does not satisfy the one or more first criteria, forgoing the initiating of the process to modify the determined route to replace the first destination with the second destination in the determined route.

16. A non-transitory computer readable storage medium storing one or more programs, the one or more programs comprising instructions, which when executed by one or more processors of an electronic device, cause the electronic device to perform a method comprising:
while the electronic device is providing navigation directions for a determined route using a maps application, detecting, via one or more input devices in communication with the electronic device, an event; and
in response to detecting the event:
in accordance with a determination that the event satisfies one or more first criteria, including a criterion that is satisfied when a level of activity associated with a first destination that is included in the determined route is greater than a threshold level of activity, wherein the first destination is associated with a preferred charging network, initiating a process to modify the determined route to replace the first destination with a second destination, different from the first destination, in the determined route; and
in accordance with a determination that the event does not satisfy the one or more first criteria, forgoing the initiating of the process to modify the determined route to replace the first destination with the second destination in the determined route.
